(19) United States
(12) Patent Application Publication
(10) Pub. No.: US 2022/0276164 A1
(43) Pub. Date: Sep. 1, 2022

(54) METHOD, SYSTEM AND MATERIAL FOR DETECTING OBJECTS OF HIGH INTEREST WITH SCANNING SYSTEMS

(71) Applicant: Terra Scientia, LLC, Palm Beach, FL (US)

(72) Inventors: John G. Aceti, New Hope, PA (US); Jonathan Bernstein, Palm Beach Garden, FL (US); Dennis Garrison, Teddington (GB)

(21) Appl. No.: 17/738,820

(22) Filed: May 6, 2022

Related U.S. Application Data
(63) Continuation-in-part of application No. 16/228,389, filed on Dec. 20, 2018.
(60) Provisional application No. 62/609,502, filed on Dec. 22, 2017.
(60) Provisional application No. 62/702,407, filed on Jul. 24, 2018.

(51) Int. Cl. G01N 21/55; G01S 7/484; G01S 17/89; G01S 7/486

(52) U.S. Cl. CPC G01N 21/55; G01S 7/484; G01S 17/89; G01S 7/486; G01N 2021/551

(57) ABSTRACT

Various embodiments include methods and scanning systems for photonically detecting an object of high-interest having selective wavelength reflection. Various embodiments include sequentially scanning the environment by projecting a non-coherent pulsed electromagnetic beam of light of a first wavelength. Reflected light of the first non-coherent beam is received onto a photoelectric detector, which outputs digital intensity data. Various embodiments further include sequentially scanning the environment by projecting a non-coherent pulsed electromagnetic beam of light of a second wavelength different from the first wavelength. Reflected light of the second non-coherent beam is received onto a photoelectric detector, which outputs digital intensity data. The intensity of the reflected light of the first wavelength may be compared with the intensity reflected light of the second wavelength, and an alert may be sent to an autonomous vehicle system in response to the intensity difference exceeding a threshold.

### RELATED APPLICATIONS

This application is a continuation-in-part of U.S. Non-provisional patent application Ser. No. 16/228,389 entitled “METHOD, SYSTEM AND MATERIAL FOR DETECTING OBJECTS OF HIGH INTEREST WITH LASER SCANNING SYSTEMS” filed Dec. 20, 2018, which claims the benefit of priority to U.S. Provisional Patent Application No. 62/609,502 entitled “METHOD, SYSTEM AND MATERIAL FOR DETECTING OBJECTS OF HIGH INTEREST WITH LASER SCANNING SYSTEMS” filed Dec. 22, 2017, and to U.S. Provisional Patent Application No. 62/702,407 entitled “SYSTEM FOR ENHANCED SAFETY OF MOBILE VEHICLES” filed Jul. 24, 2018, the entire contents of all of which are incorporated herein by reference.

### BACKGROUND

Laser scanning systems are being used to help navigate complex environments. Whether the environment is the human body, a household vacuuming robot, or city streets, these laser scanning systems have the unique ability to collect complex information from the environment. In conjunction with a computer processor and advanced algorithms, the system can detect and define physical structures, shape of objects, velocity of moving objects, and provide navigational path recommendations. What they cannot do readily is identify specific objects of interest that either lack a highly specific shape or some differentiable feature. It is therefore advantageous that these systems have another means of identifying objects of high interest that lack either of these attributes.

### SUMMARY

Disclosed herein is a method, and laser scanning system implementing the method, for detecting objects of high interest in the path, or environment, of a laser scanning system.

Various embodiments may include methods of photonically detecting an object of high-interest having selective wavelength reflection in a scanned volume. Various embodiments may include projecting coherent light of a first wavelength, receiving reflected light of the first wavelength on a photoelectric detector and outputting a digital measure of intensity of the reflected light of the first wavelength, projecting coherent light of a second wavelength different from the first wavelength, receiving reflected light of the second wavelength on the photoelectric detector and outputting a digital measure of intensity of the reflected light of the second wavelength, determining whether a difference between the intensity of reflected light of the first wavelength and the intensity of reflected light of the second wavelength exceeds a threshold, and sending an alert to a control system in response to determining that the difference between the intensity of reflected light of the first wavelength with the intensity of reflected light of the second wavelength exceeds the threshold. In some embodiments, the coherent light of the second wavelength is infrared (IR) light equal to or larger than 1100 nm and the coherent light of the first wavelength is smaller than 1100 nm.

In some embodiments, determining whether a difference between the intensity of reflected light of the first wavelength and the intensity of reflected light of the second wavelength exceeds a threshold may include detecting an IR-only retroreflector when the difference between the intensity of reflected light of the first wavelength and the intensity of reflected light of the second wavelength from a same location within in the scanned volume exceeds the threshold.

In some embodiments, projecting coherent light of the first wavelength may include projecting pulses of a first beam of coherent light of the first wavelength, projecting pulsed coherent light of the second wavelength may include projecting pulses of a second beam of coherent light of the second wavelength between pulses of the first beam and spatially coincident with the first beam. Such embodiments may further include determining a location within the scanned volume based upon a rotational angle and azimuth of the first and second beams at which the difference between the intensity of reflected light of the first wavelength and the intensity of reflected light of the second wavelength exceeds the threshold.

In some embodiments, receiving reflected light of the first and second wavelength on the photoelectric detector and outputting digital measures of intensity of the reflected light of the first and second wavelengths each comprise receiving reflected light on a pixel array of photoelectric detectors. Such embodiments may further include determining a location of an IR-only retroreflector within the scanned volume based upon locations of pixels within the pixel array at which the difference between the intensity of reflected light of the first wavelength and the intensity of reflected light of the second wavelength exceeds the threshold. Some embodiments may further include detecting a barcode or QR code constructed of IR-only retroreflectors located within the scanned volume.

In some embodiments, sending an alert to a vehicle navigation system in response to determining that the difference between the intensity of reflected light of the first wavelength and the intensity of reflected light of the second wavelength exceeds the threshold may include informing the vehicle navigation system of detection of an IR-only retroreflector.

Some embodiments may further include determining whether multiple spatially contiguous detections of intensity differences exceeding the threshold are made, wherein sending an alert to the vehicle navigation system may include sending the alert to the vehicle system navigation in response to determining that multiple spatially contiguous detections of intensity differences exceeding the threshold are made.

Some embodiments may further include summing a number of spatially contiguous detections of intensity differences exceeding the threshold, and sending an alert to the autonomous vehicle system in response to the number of spatially contiguous alerts exceeding a threshold value.

Some embodiments may further include summing a number of repeated temporal detections of an object for which the difference between the intensity of reflected light of the first wavelength and the intensity of reflected light of the second wavelength exceeds the threshold.

Some embodiments may further include determining whether a geometric shape of a detection matches a geometric shape stored in a database.

Some embodiments include a laser scanning system for use in a vehicle, that may include a first laser configured to emit coherent light of a first wavelength, a second laser configured to emit coherent light of a second wavelength different from the first wavelength, a photoelectric detector configured to determine an intensity of reflected light, and a computing device coupled to the laser sources and photoelectric detector. The computing device may be configured with processor-executable instructions to perform operations including causing the first laser to project light of the first wavelength and receiving a measure of intensity of reflected light of the first wavelength from the photodetector, causing the second laser to project light of the second wavelength and receiving a measure of intensity of reflected light of the second wavelength from the photodetector, determining whether a difference between the intensity of reflected light of the first wavelength and the intensity of reflected light of the second wavelength exceeds a threshold, and sending an alert to an autonomous vehicle system in response to determining that the difference between the intensity of reflected light of the first wavelength with the intensity of reflected light of the second wavelength exceeds the threshold. In some embodiments, the coherent light of the second wavelength is infrared (IR) light equal to or larger than 1100 nm and the coherent light of the first wavelength is smaller than 1100 nm.

In some embodiments, the computing device may be configured with processor-executable instructions to perform operations such that determining whether a difference between the intensity of reflected light of the first wavelength and the intensity of reflected light of the second wavelength exceeds a threshold may include detecting an IR-only retroreflector when the difference between the intensity of reflected light of the first wavelength and the intensity of reflected light of the second wavelength from a same location within in the scanned volume exceeds the threshold.

In some embodiments the laser scanning system may further include a laser positioning system coupled to the first and second laser and the computing device and configured to orient the first and second laser to rotation angle and azimuth coordinates and convey the rotation angle and azimuth coordinates to the computing device, in which the first laser is configured to emit a first beam of coherent light of the first wavelength, the second laser is configured to emit a second beam of coherent light of the second wavelength that is spatially coincident with the first beam. In such embodiments, the computing device may be configured with processor-executable instructions to perform operations that determine a location of an IR-only retroreflector within the scanned volume based upon a rotational angle and azimuth of the first and second beams at which the difference between the intensity of reflected light of the first wavelength and the intensity of reflected light of the second wavelength exceeds the threshold.

In some embodiments, the photoelectric detector may include a pixel array of photoelectric detectors, and the computing device may be configured with processor-executable instructions to perform operations further including determining a location of an IR-only retroreflector within the scanned volume based upon locations of pixels within the pixel array at which the difference between the intensity of reflected light of the first wavelength and the intensity of reflected light of the second wavelength exceeds the threshold. In such embodiments, the computing device may be configured with processor-executable instructions to perform operations further including detecting a barcode or QR code constructed of IR-only retroreflectors located within the scanned volume.

In some embodiments, the computing device may be configured with processor-executable instructions to perform operations such that sending an alert to a vehicle navigation system in response to determining that the difference between the intensity of reflected light of the first wavelength with the intensity of reflected light of the second wavelength exceeds the threshold may include informing the vehicle navigation system of detection of an IR-only retroreflector.

In some embodiments, the computing device may be configured with processor-executable instructions to perform operations further including determining whether multiple spatially contiguous detections of intensity differences exceeding the threshold are made. In such embodiments, the computing device may be configured with processor-executable instructions to perform operations such that sending an alert to the vehicle navigation system may include sending the alert to the vehicle system navigation in response to determining that multiple spatially contiguous detections of intensity differences exceeding the threshold are made. In such embodiments, the computing device may be configured with processor-executable instructions to perform operations further including summing a number of spatially contiguous detections of intensity differences exceeding the threshold and sending an alert to the autonomous vehicle system in response to the number of spatially contiguous alerts exceeding a threshold value.

In some embodiments, the computing device may be configured with processor-executable instructions to perform operations further including summing a number of repeated temporal detections of an object for which the difference between the intensity of reflected light of the first wavelength with the intensity of reflected light of the second wavelength exceeds the threshold.

In some embodiments, the computing device may be configured with processor-executable instructions to perform operations further including determining whether a geometric shape of a detection matches a geometric shape stored in a database.

Some embodiments may include an infrared (IR)-only device for use in tagging objects for recognition by laser scanning systems. Such IR-only devices may include a first substrate, a reflector positioned in the first substrate and having characteristics of a retroreflector, the reflector comprising a refractive component having transmissive optical properties for light with a wavelength larger than 1100 nm and absorption or scattering properties for light with a wavelength smaller than 1100 nm, and a second substrate configured to be appended to, or made part of, an object. In some embodiments, the object may be a roadway sign.

Various embodiments may include methods of photonically detecting an object of high-interest in a scanned volume. Such embodiments may include sequentially scanning the environment by projecting a coherent electromagnetic radiation beam, receiving a reflected wave of the beam onto a photoelectric detector, converting the analog output of the photoelectric detector into digital data, recording each sequential projected beam's angle and azimuth relative to a baseline, storing in memory the sequential digital data with its associated angle and azimuth, identifying any digital data representing a saturated condition, identifying presence of multiple contiguous digital data having a saturated condition, and sending an alert if one or more sets of contiguous saturated conditions exceed a pre-determined number of contiguous digital data having a saturated condition. Such embodiments may further include determining if multiple contiguous saturated amplitudes have an essential geometric shape using an image processing algorithm.

Some embodiments may include a laser scanning system that includes a laser source, a photoelectric detector, a memory, and a processor coupled to the laser emitter, photoelectric detector, and memory. In such embodiments, the processor is configured with processor-executable instructions to perform operations including sequentially scanning the environment by causing the laser source to project a coherent electromagnetic radiation beam, receiving data from the photoelectric detector receiving reflected waves of the beam, converting the analog output of the photoelectric detector into digital data, recording each sequential projected beam's angle and azimuth relative to a baseline, storing in the memory the sequential digital data with its associated angle and azimuth, identifying any digital data representing a saturated condition, identifying presence of multiple contiguous digital data having a saturated condition, and sending an alert if one or more sets of contiguous saturated conditions exceed a pre-determined number of contiguous digital data having a saturated condition. In such embodiments, the processor may be configured with processor-executable instructions to perform operations further including determining if multiple contiguous saturated amplitudes have an essential geometric shape using an image processing algorithm.

Further embodiments may include means for performing functions of any of the methods summarized above.

The system of various embodiments may be used in combination with, or integrated into, currently anticipated autonomous vehicle (AV) navigation systems, including but not limited to: LIDAR, LIDAR-Camera, Flash LIDAR, or Camera-Camera navigation systems. Various embodiments may be used with any system using an infrared (IR) illumination source for interrogating the AV's environment. As AVs should navigate by day and night, an illumination source is needed; IR illumination is invisible to the human eye and eye safe when designed properly.

Various embodiments include a taggant that is highly unique in roadside environments such that its detection indicates that a state of heightened diligence by the AV's navigation system is appropriate. The typical environment is filled with complex objects that are identified by size, color, motion, distance-to-vehicle, geometry and relative reflectivity. Retroreflectors help to identify objects of import, such as signs, emergency vehicles, roadway guides, roadside workman and large commercial vehicles. The relatively high reflectivity of these objects not only directs human attention, but can also be used by machine vision system with appropriate sensors and processing capability. AV navigation systems may continually process this information giving priority to objects of high relative reflectivity, and or high relative reflectivity and unique geometry, such as squares, triangles, or octagons. Various embodiments include methods and systems for enhancing the uniqueness of these objects, making them more readily detectable by machine vision and providing faster means of isolating objects of threat or requiring special navigation attention.

Various embodiments include the use of IR-only retroreflectors on roadways. While IR-only retroreflectors are used in specialty applications, they are not associated with AVs on traditional roadways principally because they only reflect IR radiation, which cannot be detected by a human. Given the hundreds to thousands of objects that may be detected by an AV, traditional retroreflectors limit the number of detected objects to tens to hundreds. However, many retroreflectors positioned on low threat/priority objects create noise and tend to overload the AV navigation system's processing. With IR-only retroreflectors tagging objects of high import, such as school buses, roadway signs, emergency vehicles or roadside workman, the number of detected objects expectantly drops to single digits. Fewer objects of known importance speeds processing and allows the navigation system to respond more quickly, making the identification process by the AV's navigation processor faster and more precise. With its unique optical properties, an IR-only retroreflector provides a true beacon of alert for AV vehicles.

Various embodiments include processing methods used in conjunction with sensing systems and IR-only taggant that can be used to minimize false detection of taggants. Faster more precise detection of threats and priority objects helps an AV respond faster. This helps current AVs in two ways. Faster response helps the AV travel faster, which is a limitation of current AVs. Secondly, faster detection provides more time to process data to determine whether evasive action needs to be taken both avoiding unnecessary breaking or sudden hard breaking. Various embodiments include an algorithm to minimize false alerts.

Various embodiments include methods of detecting IR-retroreflectors in an environment, which may include projecting a first wavelength of non-coherent pulsed electromagnetic radiation, capturing a first image by recording detection signal levels of the first wavelength as pixel values of the first image, projecting a second wavelength of non-coherent pulsed electromagnetic radiation, capturing a second image by recording detection signal levels of the second wavelength as pixel values of the second image, analyzing the first image and the second image for a presence of at least one IR-retroreflector, and generating an alert indicating presence of at least one IR-retroreflector in the environment in response to analysis of the first image and the second image indicating the presence of the at least one IR-retroreflector.

In some such embodiments, analyzing the first image and the second image for a presence of at least one IR-retroreflector may include generating a negative image of the second image having converted pixel values of the second image, averaging the pixel values of the first image and the converted pixel values of the negative image generating a resultant image having averaged pixel values, and determining whether at least one pixel of the resultant image has an averaged pixel value that differs from a middle value, in which generating the alert indicating presence of the at least one IR-retroreflector in the environment in response to analysis of the first image and the second image indicating the presence of the at least one IR-retroreflector may include generating the alert indicating the presence of the at least one IR-retroreflector in the environment in response to determining that at least one pixel of the resultant image has an averaged pixel value that differs from the middle value.

In some embodiments, analyzing the first image and the second image for a presence of at least one IR-retroreflector may further include determining whether a number of pixels of the resultant image that have averaged pixel values that differ from the middle value falls short of a pixel count threshold, in which generating the alert indicating the presence of the at least one IR-retroreflector in the environment in response to determining that at least one pixel of the resultant image has an averaged pixel value that differs from the middle value may include generating the alert indicating the presence of the at least one IR-retroreflector in the environment in response to determining that at least one pixel of the resultant image has an averaged pixel value that differs from the middle value and in response to determining that the number of pixels of the resultant image that have averaged pixel values that differ from the middle value falls short of the pixel count threshold.

In some embodiments, analyzing the first image and the second image for presence of at least one IR-retroreflector may further include determining whether a number of contiguous pixels of the resultant image having averaged pixel values that differ from the middle value exceeds a contiguous pixel threshold, in which generating the alert indicating presence of the at least one IR-retroreflector in the environment in response to determining that at least one pixel of the resultant image has an averaged pixel value that differs from the middle value may include generating the alert indicating presence of the at least one IR-retroreflector in the environment in response to determining that at least one pixel of the resultant image has an averaged pixel value that differs from the middle value and in response to determining that the number of contiguous pixels of the resultant image having averaged pixel values that differ from the middle value exceeds the contiguous pixel threshold.

In some embodiments, projecting the first wavelength and projecting the second wavelength may occur at different times. In some embodiments, projecting the first wavelength and projecting the second wavelength may occur approximately simultaneously.

Further embodiments include a system for detecting IR-retroreflectors in an environment, which may include means for projecting a first wavelength of non-coherent pulsed electromagnetic radiation, means for capturing a first image by recording detection signal levels of the first wavelength as pixel values of the first image, means for projecting a second wavelength of non-coherent pulsed electromagnetic radiation, means for capturing a second image by recording detection signal levels of the second wavelength as pixel values of the second image, means for analyzing the first image and the second image for a presence of at least one IR-retroreflector, and means for generating an alert indicating presence of at least one IR-retroreflector in the environment in response to analysis of the first image and the second image indicating the presence of the at least one IR-retroreflector.

In some embodiments, means for analyzing the first image and the second image for a presence of at least one IR-retroreflector may include means for generating a negative image of the second image having converted pixel values of the second image, means for averaging the pixel values of the first image and the converted pixel values of the negative image generating a resultant image having averaged pixel values, and means for determining whether at least one pixel of the resultant image has an averaged pixel value that differs from a middle value, in which means for generating the alert indicating presence of the at least one IR-retroreflector in the environment in response to analysis of the first image and the second image indicating the presence of the at least one IR-retroreflector may include means for generating the alert indicating the presence of the at least one IR-retroreflector in the environment in response to determining that at least one pixel of the resultant image has an averaged pixel value that differs from the middle value.

In some embodiments, means for analyzing the first image and the second image for a presence of at least one IR-retroreflector may further include means for determining whether a number of pixels of the resultant image that have averaged pixel values that differ from the middle value falls short of a pixel count threshold, in which means for generating the alert indicating the presence of the at least one IR-retroreflector in the environment in response to determining that at least one pixel of the resultant image has an averaged pixel value that differs from the middle value may include means for generating the alert indicating the presence of the at least one IR-retroreflector in the environment in response to determining that at least one pixel of the resultant image has an averaged pixel value that differs from the middle value and in response to determining that the number of pixels of the resultant image that have averaged pixel values that differ from the middle value falls short of the pixel count threshold.

In some embodiments, means for analyzing the first image and the second image for presence of at least one IR-retroreflector may further include means for determining whether a number of contiguous pixels of the resultant image having averaged pixel values that differ from the middle value exceeds a contiguous pixel threshold, in which means for generating the alert indicating presence of the at least one IR-retroreflector in the environment in response to determining that at least one pixel of the resultant image has an averaged pixel value that differs from the middle value may include means for generating the alert indicating presence of the at least one IR-retroreflector in the environment in response to determining that at least one pixel of the resultant image has an averaged pixel value that differs from the middle value and in response to determining that the number of contiguous pixels of the resultant image having averaged pixel values that differ from the middle value exceeds the contiguous pixel threshold.

In some embodiments, means for projecting the first wavelength and projecting the second wavelength may include means for projecting the first wavelength and projecting the second wavelength at different times. In some embodiments, means for projecting the first wavelength and projecting the second wavelength may include means for projecting the first wavelength and projecting the second wavelength approximately simultaneously.

Various embodiments include a system for detecting IR-retroreflectors in an environment, which may include a first illumination source configured to output an infrared (IR) electromagnetic radiation of a first wavelength, a second illumination source configured to output IR electromagnetic radiation of a second wavelength different from the first wavelength, a first optic configured to focus IR electromagnetic radiation of the first wavelength and the second wavelength on a field of view, a second optic configured with a field-of-view similar to the field of view of the first optic, at least one photodetector configured with spectral sensitivity to IR electromagnetic radiation of the first wavelength and the second wavelength, and a computing device coupled to the first illumination source, the second illumination source, and the at least one photodetector. In some embodiments, the computing device may be configured with computing device-executable instructions to perform operations that may include controlling a sequence of outputting IR electromagnetic radiation of the first wavelength by the first illumination source and IR electromagnetic radiation of the second wavelength by the second illumination source, receiving detection signal levels of IR electromagnetic radiation of the first wavelength measured by the at least one photodetector and detection signal levels of IR electromagnetic radiation of the second wavelength measured by the at least one photodetector, and generating an alert configured to indicate presence of at least one IR-retroreflector in the environment.

In some embodiments, the computing device may be configured with computing device-executable instructions to perform operations that may further include controlling a duration of outputting IR electromagnetic radiation of the first wavelength by the first illumination source and IR electromagnetic radiation of the second wavelength by the second illumination source.

In some embodiments, the computing device may be configured with computing device-executable instructions to perform operations such that controlling the sequence of outputting IR electromagnetic radiation of the first wavelength by the first illumination source and IR electromagnetic radiation of the second wavelength by the second illumination source may include controlling outputting IR electromagnetic radiation of the first wavelength by the first illumination source and IR electromagnetic radiation of the second wavelength by the second illumination source at different times.

In some embodiments, the computing device may be configured with computing device-executable instructions to perform operations such that controlling the sequence of outputting IR electromagnetic radiation of the first wavelength by the first illumination source and IR electromagnetic radiation of the second wavelength by the second illumination source may include controlling outputting IR electromagnetic radiation of the first wavelength by the first illumination source and IR electromagnetic radiation of the second wavelength by the second illumination source approximately simultaneously.

In some embodiments, the first wavelength may be less than a value selected from a range between approximately 900 nm and approximately 1,500 nm. In some embodiments, the second wavelength may be greater than a value selected from a range between approximately 900 nm and approximately 1,500 nm. In some embodiments, the first wavelength and the second wavelength may each be configured for one of reflectance property of the IR-retroreflector and a non-reflectance property of the IR-retroreflector.

In some embodiments, the at least one photodetector may be a CMOS detector. In some embodiments, the at least one photodetector may be an InGaAs detector array. In some embodiments, the at least one photodetector includes a first photodetector configured with spectral sensitivity to IR electromagnetic radiation of the first wavelength and a second photodetector configured with spectral sensitivity to IR electromagnetic radiation of the second wavelength.

Various embodiments include a threat detection system which minimizes physical threat to the vehicle, or a physical threat to an object by the vehicle, such as a pedestrian, or a threat of violating a law or regulation, or a threat of violating commonly understood codes of roadway courtesy.

### BRIEF DESCRIPTION OF THE DRAWINGS

The accompanying drawings, which are incorporated herein and constitute part of this specification, illustrate example aspects of various embodiments, and together with the general description given above and the detailed description given below, serve to explain the features of the claims.

FIG. 1 is a schematic block diagram of a system for photonically detecting an object of high-interest in a scanned volume, in accordance with various embodiments.

FIG. 2 is a diagram showing the relative reflections amplitude of a retroreflector vs other reflectors in accordance with various embodiments.

FIG. 3 is a graph showing the transmission efficiency vs. wavelength of retroreflective materials.

FIG. 4 is a graphic representation of a retroreflection in a cross-section of a glass bead.

FIG. 5 is a graph showing an example of one material's transmittance spectra in terms of the percentage of transmittance vs. the wavelength of transmittance.

FIG. 6 is a graphic representation of a cross-section of a retroreflector selectively reflecting IR wavelengths.

FIG. 7 is a graphic representation of a cross-section of a retroreflector with a wavelength-selectable retroreflector coating according to various embodiments.

FIG. 8 is a schematic block diagram of an integrated dual wavelength LIDAR system for integrating two different pulsed laser wavelengths into a single LIDAR system for detection of an IR-only retroreflector according to various embodiments.

FIG. 9 is a schematic block diagram of a dual LIDAR system that adds a laser scanning system to an existing LIDAR system but having a different projected wavelength for detection of an IR-only retroreflector according to various embodiments.

FIG. 10 is a schematic block diagram of a Flash LIDAR system that adds a Flash-laser system to another Flash-LIDAR system having a different projected wavelength for detection of an IR-only retroreflector.

FIG. 11 is a graphic representation of some basic geometric shapes of common roadway signs.

FIG. 12 is a graphic representation of roadside signs enhanced for machine vision identification in accordance with various embodiments.

FIG. 13 is a graphic illustration of the reflection of electromagnetic radiation from any angle back to the source in accordance with various embodiments.

FIG. 14 is a graph showing the characteristic opacity of several polymers between 200 and 2000 nm.

FIG. 15 is a graph showing the bandpass profile for a dichroic filter or absorber.

FIG. 16 is a graphical representation of the resolution of a conventional LIDAR system.

FIG. 17 is a graphical illustration of a traditional shape and standardized size of a school bus stop sign.

FIG. 18 is a graphical representation of the resolution of a Velodyne® LIDAR system.

FIG. 19 is a process flow diagram illustrating a method of processing LIDAR scans according to various embodiments.

FIG. 20 is process flow diagram illustrating another method of processing LIDAR scans according to some embodiments.

FIG. 21 is a component diagram illustrating an example of a computing device in the form of a system on chip suitable for use in various embodiments.

FIGS. 22A and 22B are schematic block diagrams of a non-coherent, dual wavelength LED IR-retroreflector detection system according to various embodiments.

FIG. 23 is a graph showing example IR wavelengths for IR LED illumination sources.

FIG. 24 is a graph showing an example of one IR-retroreflector's spectral response in terms of the percentage of transmittance vs. the wavelength of transmittance.

FIG. 25 is a graph showing the spectral response of a silicon photodetector in terms of strength of sensitivity vs. wavelength of reception.

FIG. 26 is a graph showing the spectral response of an InGaAs photodetector in terms of quantum efficiency vs. wavelength of reception.

FIG. 27 is a process flow diagram illustrating a method of processing non-coherent, dual wavelength LED illumination according to various embodiments.

FIG. 28 is a process flow diagram illustrating a method of processing non-coherent, dual wavelength LED illumination according to various embodiments.

FIG. 29 is a process flow diagram illustrating a method of processing non-coherent, dual wavelength LED illumination according to various embodiments.

FIG. 30 is a graphical representation of processing non-coherent, dual wavelength LED illumination.

FIG. 31 is a graphical representation of an application of IR-retroreflectors in an environment for detection by a non-coherent, dual wavelength LED IR-retroreflector detection system.

### DETAILED DESCRIPTION

Various embodiments improve the detection of existing retroreflectors, such as in the form of detecting objects of import, without the need for the IR-only retroreflectors. In addition, various embodiments improve contemporary road signs by using dual wavelengths to detect retroreflectors, rather than a single wavelength. The use of dual wavelengths provides far less noise and is therefore a more sensitive and reliable system of detection. In the context of laser scanning systems, such as those using IR-only retroreflectors, providing this type of redundancy is advantageous and may comparatively detect objects of import at a greater distance. Such systems, in the context of navigation, may eliminate unnecessary braking and/or provide more gradual breaking when needed.

Various embodiments may be applied to a broad range of safety and communication systems and components, such as signs, tags, IR-only QR codes, and more. Due to the highly specific and sensitive nature of IR-only retroreflectors, various embodiments provide enhanced specificity and added redundancy, which is beneficial for safety systems. Various embodiments provide more rapid detection, which in the context of AVs may provide added safety and a more comfortable ride.

Some embodiments may be best illustrated by the situation of a semi-autonomous or fully autonomous vehicle approaching a school bus. School buses often operate in low-visibility conditions, such as early morning, or in poor weather, or in rural areas where artificial lighting may be poor. While their yellow color may give them conspicuity during the day, darkness, fog, or haze may render them difficult to detect by machine vision. To improve their visibility, many authorities require the use of retroreflective tape on school buses, making the vehicle easier to detect. The various embodiments enable detecting the presence of that retroreflecting stripe and provide an alert to a vehicle's control system. The detection of the retroreflector provides an alert to the system that an object of import is near and appropriate actions may be required.

In the case of a school bus, certain laws demand that the vehicle may not pass the bus as it may do so with other vehicles on the road. The detection of the retroreflector on the school bus should be detected and cause the control system to use other means, such as a camera, to further identify the object of import. Today's LIDAR system does not identify objects, it is designed to only determine the size, distance and trajectory of objects around the vehicle. The means by which a LIDAR system can detect a retroreflector in a vehicle's environment is further described herein.

In some embodiments, an existing LIDAR system may be used, and in other embodiments, a dedicated scanning laser-detector system may be used. Most semi-autonomous and autonomous vehicles being developed for commercial applications use LIDAR systems and various embodiments herein may be incorporated into such systems. On vehicles not currently using a LIDAR system, a simpler laser scanning and detection system may be used. Railway systems do not currently use LIDAR, but by incorporating a laser-scanning and retroreflector detection system into the front locomotive, fatal accidents involving workers on the tracks wearing retroreflective vests may be avoided. Some embodiments may be utilized for any moving vehicle to avoid objects tagged with retroreflective material.

One other means of identifying objects of specific interest but variable shape is by combining LIDAR with a means of capturing visible imagery. Cameras, in communication with advanced image processing tools can be programmed to identify objects of specific interest. For example, a self-driving car will combine a laser scanning system with a visible camera to detect a school bus by its shape, color and features. The school bus is an object of specific interest because the navigation rules about the bus are defined by laws that may be different than that which would be applied to navigation about an ordinary bus.

Another means of identifying objects of specific interest is to tag the object. For example, a laser scanning system to detect cancer cells in vivo may use a color camera to detect the unique fluorescent signature of cells when illuminated by UV electromagnetic radiation. However, many other types of cells fluoresce so there is a need to tag the cancer cells to uniquely identify them. A color camera in combination with a scanning laser may be used. It would be simpler and less expensive if the scanning laser itself could identify these unique cells. By way of example, a laser scanning system for navigating self-driving vehicles is receiving great attention and will be used here to further clarify problems in such systems and to illustrate the usefulness of various embodiments.

The use of a self-driving vehicle as an illustration of the problem and an illustration of the capacity of various embodiments is not intended to limit the disclosure or the claims.

Self-driving vehicles are progressing in sophistication and safety with semi-autonomous vehicles already on the road and fully autonomous vehicles in various stages of prototyping. These vehicles use various technologies, both singularly and in combination, to provide a means by which their control system may sense the environment, have a predetermined drive path, and navigate the vehicle through the ever changing and challenging environment. The effort to launch these vehicles commercially is relentlessly advancing.

Levels of vehicle automation are envisioned and being developed by the various automotive companies around the world. The International Society of Automotive Engineers has defined six levels which are detailed in their guideline; Levels of Driving Automation for On-Road Vehicle. This guideline defines levels from no automation to full automation with four intermediate levels. Today, Level 2 systems are on the road. Lexus® (Nagoya, Japan) uses a “hands-off” automated system that takes full control of the vehicle (accelerating, braking, and steering). At this level the driver must monitor the driving and be prepared to immediately intervene at any time if the automated system fails to respond properly. The shorthand “hands off” is not meant to be taken literally. In fact, contact between hand and wheel is often mandatory during SAE 2 driving, to confirm that the driver is ready to intervene.

In 2017, Audi® (Ingolstadt, Germany) announced being the first Level 3 (“eyes off”) commercial vehicle with its Audi A8 Luxury Sedan. In this model, the driver can safely turn their attention away from the driving tasks, e.g. the driver can text or watch a movie. The vehicle will handle situations that call for an immediate response, like emergency braking. The driver must still be prepared to intervene within some limited time, specified by the manufacturer, when called upon by the vehicle to do so. When activated by the human driver the car takes full control of all aspects of driving in slow-moving traffic at up to 60 kilometers per hour. The function only works on highways with a physical barrier separating oncoming traffic.

To support all levels of automation, today there are three types of navigation systems being evaluated: 1) Camera over radar relies predominantly on camera systems, supplementing them with radar data; 2) Radar over camera relies primarily on radar sensors, supplementing them with information from cameras; and 3) a hybrid approach that combines light detection and ranging (LIDAR), radar, camera systems, and sensor-fusion algorithms to understand the environment at a more granular level. Each of these systems has its pros and cons.

Most systems currently under development are hybrid and include LIDAR for navigation—a notable exception is the current TESLA guidance system which uses camera and radar. It is the function of LIDAR to determine where it is safe to drive. LIDAR is a surveying method for measuring distance to a target by illuminating that target with a pulsed laser light, and measuring the time-of-flight of reflected pulses with a sensor (photodetector). To do so, a LIDAR system scans the vehicle's full environment, typically 360 degrees in the horizontal and about 27 degrees in the vertical, and in some systems does so up to twenty times a second. The system is continuously detecting and defining objects all around, as well as their distance, size and trajectory. In doing so, a LIDAR system creates what is called a ‘point map’ so that software algorithms can classify objects all around the vehicle as stationary or in motion. Combining sensor data with computer algorithms, the system is capable of defining objects currently in in the path of the vehicle and/or objects with trajectories that will be in the path of the vehicle. Examples of obstacle detection and avoidance products that leverage LIDAR sensors are the Autonomous Solution, Inc. Forecast 3D Laser System and Velodyne® (Velodyne Lidar, San Diego, Calif.).

Despite extensive real-world testing, these systems are still error prone. The first deadly crash involving a semi-autonomous vehicle occurred in Williston, Fla. on May 7, 2016 while a Tesla Model S® (Palo Alto, Calif.) electric car was engaged in Autopilot mode. The crash occurred when a tractor-trailer made a left turn in front of the Tesla at an intersection on a non-controlled access highway, and the car failed to apply the brakes. The car continued to travel after passing under the truck's trailer. Note that the Tesla does not use LIDAR for navigation.

Less deadly but still concerning is the crash on Feb. 14, 2016, when a Waymo® (Alphabet Inc., Mountain View, Calif.) automatic vehicle (VA) attempted to avoid sandbags blocking its path. The vehicle had moved to the far-right lane to make a right turn, but stopped when it detected sand bags sitting around a storm drain and blocking its path. The Waymo AV began to proceed back into the center of the lane to pass the sand bags. As the Waymo AV was reentering the center of the lane, it made contact with the side of a bus. It was using a LIDAR system.

While navigation systems will continue to evolve and become more reliable, there will continue to be situations and context in which the vehicle's control system may not detect, and therefore not react, to the challenge of an unexpected or complex overload of competing threats. It would be advantageous then for these systems to have a more fail-safe means of detecting objects of potential concern and react accordingly or alert the vehicle's occupant.

It would therefore be advantageous to alert the vehicle's control system to objects of superior priority that are about the vehicle. Objects that present a particular concern to a semi-autonomous vehicle or an autonomous vehicle are objects that may pose a threat to the vehicle, or where the vehicle may pose a threat to the object, or where the object requires an action other than avoidance. For example, with the accident involving the Tesla and the trailer tractor, the trailer was a clear threat to the car but its navigation system failed to recognize it as such. A semi-autonomous or autonomous vehicle may pose a threat to objects on the road, such as workers on the side of the road, where the presence of workers may be an unexpected obstacle on the road and not recognized as such. Or the detection of an object may require a certain action by the vehicle that is unique by law, such as not passing a stopped school bus or maintaining a certain separation distance when passing a bicyclist. These objects are not identified as requiring special actions as LIDAR does not identify objects.

LIDAR by design determines distance, object size and trajectory but does not uniquely identify the object. In human navigated cars, objects about the vehicle are readily identified, and appropriate action is taken by the driver. Even then, objects of import such as a school bus, road worker, or bicyclist have special rules, regulations or common courtesy that should be obeyed.

Further, regulators have evolved a series of laws, regulations, or standards to further improve vehicle safety by heightening the identification of objects of import via standardized colors, lights, and shapes therefore making it easier for the human eye to detect and thereby improve safety and avoid collisions. Most notable are; tail lights, brake lights, traffic control and direction signs, barriers and flags. Active highlighting, such as tail lights, brake lights, and stop lights are reserved for the most critical situations. Conversely, passive highlighting is used in less critical situations, such as traffic control signs, directional signage, or barriers. However, the human eye and brain can, in some complex situations, be overwhelmed by the intensity or density of information that typically must be processed in seconds or even milliseconds to avoid accidents. In particular, in low light or dark conditions the use of retroreflective material has been mandated as a passive highlighting mechanism. To help the driver, certain standards in the form of laws and regulations have evolved to dictate the appearance of some common road objects.

For example, the National Highway Traffic Safety Administration (NHTSA) in the US published a rule requiring that commercial vehicles of certain size be equipped on the sides and rear with a means for making them more visible on the road. More specifically, NHTSA rule dictates trailer manufacturers install either red and white retroreflective sheeting or reflex reflectors. These materials must further be of a certain width, DOT-C2 50 millimeter (mm) wide, DOT-C3 75 mm wide retroreflective sheeting, or DOT-C4 100 mm wide retroreflective sheeting. Further, there are standards for retroreflective materials for traffic control as outlined in the American Society for Testing and Materials (ASTM) D4956-90, published December 1990, “Standard Specification for Retroreflective Sheeting for Traffic Control.” (ASTM International, 100 Barr Harbor Drive, PO Box C700, Conshohocken, Pa. 19428-2959)

A retroreflector is a device or surface that reflects light back to its source with a minimum of scattering. Unlike a mirror, a retroreflector reflects light directly back to the light source. A mirror only does so if the light source is perpendicular to the mirror. Therefore, a retroreflector can reflect light back to a car as it moves and changes its angle relative to the retroreflector. This is particularly helpful in road signage where the sign is illuminated brightly for a driver as the vehicle approaches and passes the sign. Vehicles adorned with retroreflectors are readily apparent regardless of the angle of the retroreflector to the driver. For example, the retroreflector on the side of a trailer on a dark night will reflect the light of a vehicle's headlights back to the driver making the trailer much more conspicuous. Therefore, retroreflectors have helped to avoid many collisions.

A primary use of retroreflectors is in signage. Road signs use shapes, colors, words, and symbols to communicate a message to drivers but virtually all traffic signs use retroreflective sheeting. This sheeting, designed to reflect some of the light from an approaching vehicle's headlights back to the driver, will make the sign visible at night. Sign shape can also provide cues to motorists even when the words or symbols on the sign are unintelligible by defining the shape with retroreflective sheeting. The Federal Highway Administration in the US has developed the design details of signage which is found in its Manual on Uniform Traffic Control Devices for Streets and Highways. In the regulation, it specifies that: Regulatory signs shall be retroreflective or illuminated to show the same shape and similar color by both day and night, unless specifically stated otherwise in the text discussion in this.

Another ubiquitous use of retroreflectors is in road stripping—the typically white lines that run along the center and shoulder of a road. In the early 1940's, during World War II, reflective beaded lines were used on highways in the US to expedite traffic during blackouts. World War II was largely responsible for the widespread acceptance of incorporating retroreflective beads into stripping to provide nighttime delineation due to the blackout condition imposed. Using beaded lines for nighttime reflectivity is now accepted worldwide. The advantages of using reflective beads are apparent when driving on a rural road at night.

More recently, roadways have been blanketed with Raised Pavement Markers, these are the retroreflectors embedded in the centerline of the road to provide point reflections for motorists and help to separate opposing traffic. In the UK, they are referred to as Cat's eyes, and consist of two pairs of retroreflective glass spheres set into a white rubber dome, mounted in a cast-iron housing. They generally come in a variety of colors and have enjoyed widespread usage in the British Isles and elsewhere around the world.

Another use of retroreflectors is defined by ANSI/ISEA's February 2016 High Visibility Clothing standard update, the ANSI/ISEA 107 High Visibility Safety Apparel, and the ANSI/ISEA 207 Public Safety Vest standards for workers on the road or for fire, police and medical personnel. These specifications allow for both silver reflective and prismatic materials meeting the ANSI/ISEA 107-2010 High Visibility Standard, and both are retro-reflective—light from traffic is reflected from the safety tape back to the drivers, allowing them to see roadside workers sooner and at greater distances.

Our roadways have evolved methods and technology to make driving safer by highlighting objects of concern. How will semi-autonomous or autonomous vehicles leverage these same methods and technology? For example, had the Tesla's navigation system, mentioned earlier, had a means of detecting the unique signature of a retroreflector on the side of the tractor trailer it may have avoided the crash. Similarly, if the Waymo car had a means of detecting the retroreflector on the side of the commercial bus, it may have avoided the accident. Clearly, there is need for vehicle navigation to leverage the ubiquitous use of retroreflectors as a means of alerting the control system or the occupant of an object of concern.

The definition of a semi-autonomous or autonomous vehicle is not intended to be limited to roadway vehicles such as cars, buses, trucks, tractor-trailers but also extends to railroad locomotives, sailing vessels, robotics, airborne low-flying vehicles such as drones, or any device under locomotion.

The burgeoning market for semi-autonomous and autonomous vehicles (AVs) is challenging current technology to navigate safely through our ever changing and congested environment. As AV developers test their designs in real-world environments, reports of accidents are increasing, some fatal to driver and pedestrian alike. With every accident, there is a pursuit by developers for an answer to a new problem. How can the navigation system of an AV have avoided that accident? Can an AV's navigation system ever be perfected to anticipate every new threatening situation?

As with all burgeoning technology, technological trade-offs are being made to expeditiously enter the market with available technology and acceptable minimal performance specifications. These trade-offs are elected to focus and address the primary threats to an AV. Speed of surveillance (the number of scans per second), for example, is necessarily increased to improve reaction time by lowering spatial resolution. However, lower resolution means limited ability to identify objects. Being able to detect threats and identify objects then necessitates additional equipment, such as combining LIDAR systems with visible imaging cameras. Fusing data from two systems necessitates more processing power, which drives up system cost.

Reaction time is critical. Detecting and processing a threat and assuring safety takes computational effort and is tempered by the need to minimize unnecessary slowing or breaking.

A fundamental challenge is that AV systems are being designed to navigate an environment that has been optimized for human vision and not machine vision. If ultimate safety is to be achieved, the environment must be, and will eventually be, designed to leverage the strengths and capabilities of machine vision and electronic sensors. For example, when humans view a stop sign, the letters of the stop sign are clearly readable at a reasonable distance, the color red is unique, and the octagonal geometry is uniquely associated with stop, providing three visual clues regarding the meaning of this critical element of traffic control. A camera and computer vision system, given sufficient light and sufficient resolution can also image and interpret the same sign. But most guidance systems today use LIDAR (light detection and ranging), which is blind to color and lacks resolution to ‘read’ the sign. Thus, a LIDAR system is joined with a camera system in AVs to obtain sufficient information about the environment to enable safe navigation. Fusing LIDAR data with camera data takes valuable computation time and involves another layer of processing to enable safe navigation.

Combining data from LIDAR and camera, and/or other combinations of navigation technology, such as radar and cameras, or Flash LIDAR and cameras, demands more complex systems that may never be perfectly capable of navigating an environment in continual flux. Some AV systems attempt to combat these challenges by anticipating the sharing of data. For example, a forward vehicle making an avoidance maneuver may wirelessly transmit information regarding the maneuver or threat situation to enable following AVs to perform the same or similar maneuvers. Many scenarios present changes in the roadway environment that software engineers are still grappling with how to minimize threat to the vehicle or vice versa.

As with many complex man-designed systems, one answer to the safety concern is redundancy. Modern airliners have redundancy such that one engine can fail and the plane safely flies. Redundant braking systems, still the norm in passenger vehicles, uses hydraulic breaking backed by driver electable mechanical breaking. Combining a LIDAR system with a camera, for example, is not redundancy; rather, the combination is a single primary system for locating and recognizing objects and threats.

All roadway designs have benefited from an understanding of how the human driver senses and responds to the environment. Driver vision is helped with lighting at key intersections and brightly painted guidelines to help the driver maintain the vehicle in an appropriate position on the road—often with less than a meter away from another passing vehicle. Roadway engineering considers signs and guides for control, direction and safety. Roadway designs, signs and guides have been standardized over the years and proven to work well for human drivers.

With AVs, the current state of retroreflector use optimized for humans may not be appropriate or optimized for the capabilities and trade-offs of electronic sensors and navigation systems. To significantly enhance detection by AVs and improve safety of AVs, a system is needed that leverages redundant threat identification and leverages retroreflective taggants optimized for detection by machine vision systems.

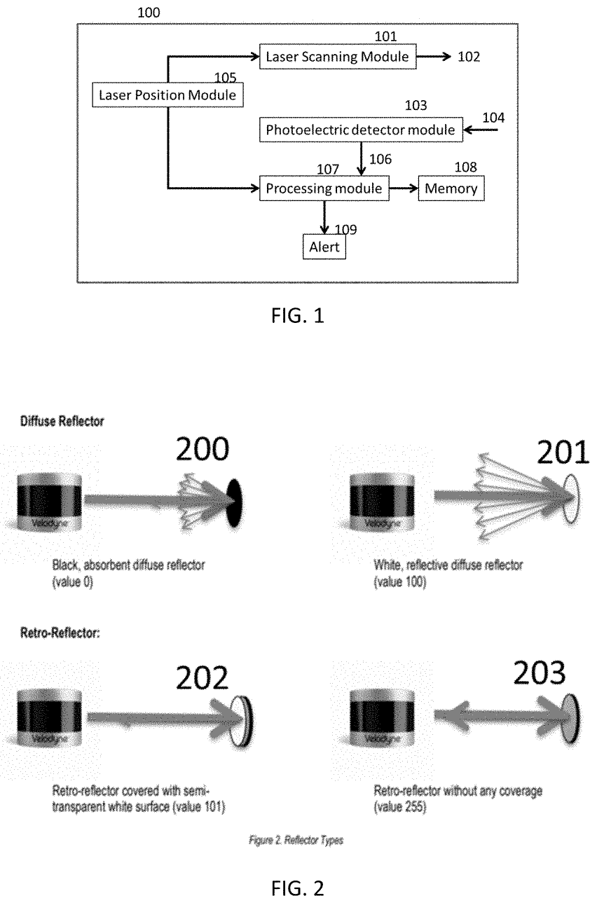

FIG. 1 illustrates a schematic block diagram of a system 100 for photonically detecting an object of high-interest in a scanned volume. A laser source 101, typically an eye-safe infrared wavelength (940 nm or 1550 nm) is used to project a coherent wave 102. A photoelectric detector 103 is collocated with the laser source 101 such that reflections 104 of the laser source may be detected. While conventional LIDAR systems use the time-of-flight to determine distance, the system 100 uses the amplitude of the reflected light 104.

Laser aiming, both in rotational angle and azimuth, is controlled by and recorded by the laser positioning module 105. The laser positioning module 105 comprises motors that orient the laser or lasers to rotation angle and azimuth coordinates, and is configured convey rotation angle and azimuth coordinates to the processing module 107. The processing module 107 is a computing device configured to control the laser source 101 and laser positioning module 107 and receive data from the laser positioning module and the photoelectric detector 103. For each unique coordinate of rotation angle and azimuth there is also a corresponding reflection amplitude detection that is sensed by the Photoelectric Detection Module 103. For systems using a 2D system, the x, y coordinate system may be used to store point measurements.

The Photoelectric Module 103 detects only the wavelength of the scanning source and converts the sensed light into an electrical signal, which in turn is converted into a digital code. The digital code that represents the intensity of the received signal is typically represented in binary code between 0 and 255 with 255 representing saturation of the detector. In LIDAR systems, the reflected signal is averaged to the mid-values by varying the strength of the light source. For this reason, most objects will have a reflection amplitude much less than the saturated level of 255. In some cases, where the average reflected amplitude for a scene is low, the definition of a saturated level may be considered to be less than 255 but significantly above the average reflected amplitude.

In some embodiments, the photoelectric detector 103 is a single (i.e., 1D) detector having a single amplitude value for light impinging upon it. Such a detector may include a collimator such that light striking the detector is limited to a narrow angle. Such a photoelectric detector 103 may be positioned parallel to the laser source 101 (e.g., boresighted with the laser) so that the detector measures the intensity of reflected light along the axis of the laser beam. In such embodiments, the location of a retroreflector in the environment may be determined based upon the rotational angle and azimuth of the laser positioning module 105, as well as the time-of-flight data that can be used by the processing module 107 to determine the distance to an object such as a retroreflector.

In some embodiments, the photoelectric detector 103 may include an array of detectors organized as pixels (i.e., a 2D detector). In such embodiments, the photoelectric detector 103 may include a lens configured to focus light onto the detector array similar to digital cameras. In such embodiments, the location of the retroreflector in the environment may be determined based upon the X, Y coordinates of the pixel or pixels within the detector array that detect retroflected light (e.g., indicating an amplitude at or near the saturation level of 255), in combination with the rotational angle and azimuth of the laser positioning module 105, as well as the time-of-flight data that can be used by the processing module 107 to determine the distance to an object such as a retroreflector.

The Processing Module 107 receives an incremental coordinate of rotational angle and azimuth from the laser positioning module 105 and simultaneously a value from the Photoelectric Detection Module representing the digital value of the sensed light intensity 106. The processing module 107 may also receive a time value for light detections from the photoelectric detection module 103, which may enable the processing module to determine the time-of-flight, and thus the distance to the object reflecting light. The Processing Module 107 may store each pair of location and intensity data in Memory 108. When an entire scan is complete, typically comprising a 360-degree sweep and about a 27-degree elevation, an analysis is done by the Processing Module 107 of the stored values using a software algorithm Executing the software algorithm, the Processing Module 107 will search for contiguous saturated points. Embodiment systems that use a 2-D point map may use a raster scan to produce a 2D array of measurements with the X-Y coordinates and reflection amplitude values similarly stored and analyzed.

A ‘closest neighbor’ software algorithm may be used by the Processing Module 107 to detect the number of contiguous saturated values of all the values collected in a single full scan. The number of contiguous saturated values depends on the resolution of the system and the relative size of the retroreflector. Typical LIDAR systems may have a resolution of about 2 cm at distance. Thus, a commercial vehicle may have a retroreflector strip 4 to 6 cm in width and 200 to 1000 cm or more in length. A safety vest may have a retroreflector strip of 4 cm wide and more than 24 cm long. Thus, a threshold of 10 to 100 saturated contiguous hits may be used to reduce false alarms.

FIG. 2 depicts the relative reflection amplitude in a LIDAR system amongst black objects 200, white specular objects 201, an occluded retroreflector 202, and a bare retroreflector 203. The relative equivalent binary representations of the reflected intensity are respectively: 0, 100, 101, and 255. Where 255 represents the typical value associated with a retroreflector in a scene and is also the saturation level of the photodetector—there can be no higher value.

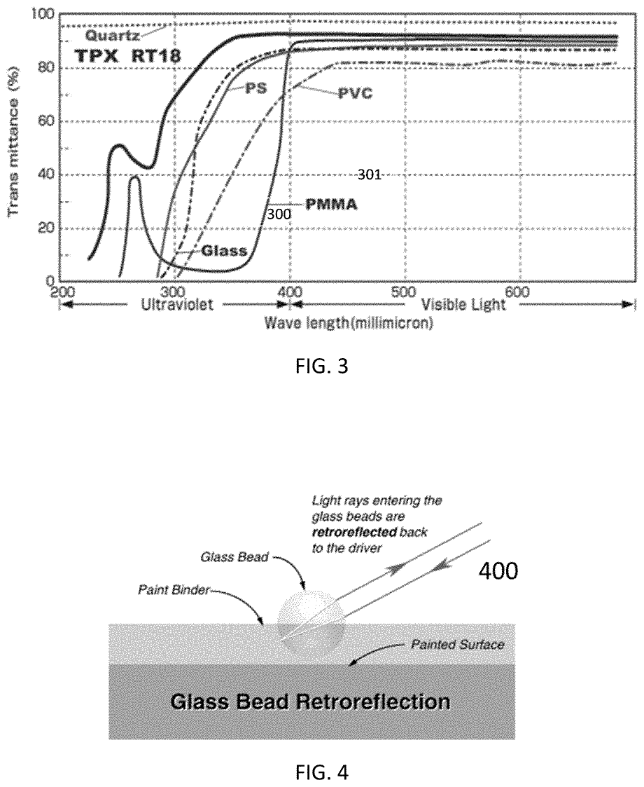

FIG. 3 is a graph showing the transparency as a function of wavelength of materials typically used to manufacturer retroreflecting beads. Glass 300 and PMMA 301 are shown to be as transparent in the visible spectrum as they are for the infrared wavelengths of interest in LIDAR scanning systems. This means that both glass and plastic retroreflectors will be as responsive to infrared as they are to the white light of a car's headlight.

FIG. 4 illustrates the optics of an individual retroreflector bead 400. Road signs, raised pavement markers, road way stripping, and signage typically have hundreds to many millions of these beads with each acting to reflect the imposed light. Key to the high brilliance of a retroreflector is the fact that light rays are reflected directly back to the source—regardless of the angle of incidence. This suggests that retroreflectors, to the side or skewed relative to the projection system, are also detectable. It further suggests the need to have the photoelectric detector 103 collocated with the laser source.

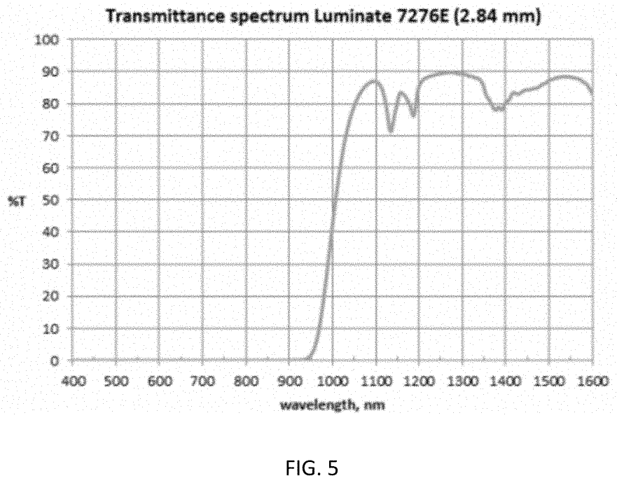

FIG. 5 is a graph showing the transmittance as a function of wavelength of a special polymer mix that is opaque to visible light but transparent to IR light. Various embodiments include IR reflective retroreflective beads made of such polymer materials. These unique beads may be the future standard for retroreflective taggants of various embodiments to enable LIDAR systems to identify objects of heightened avoidance. Polymers may work uniquely with IR systems, and not be detectable by the human eye. As such, various embodiments provide a unique means of heightening awareness by LIDAR systems for self-driving autonomous vehicles.

When an AV is operational it may use a LIDAR system or another dedicated laser-scanning system. As the scanning system scans the environment it is constantly detecting objects of certain size and trajectory. Various embodiments allow for the additional function of detecting objects displaying retroreflectors. Detecting any number of retroreflectors in a vehicle's environment can activate the system providing the number of contiguous detections for any grouping exceeds a predefined threshold. Since the IR laser is operational day and night, so is the detection of retroreflector, because the optics of LIDAR systems typically have an IR filter to block visible light from reaching the photodetector. This is a key point; the detection of retroreflectors that work predominantly for human drivers at night superiorly work for an IR scanning system day and night.

Detection of ubiquitous retroreflectors on and about the roadway, such as a raised pavement marker, signage, and stripping, will be detected along with retroreflectors associated with objects of heightened priority. Such detections may be dismissed as a false alarm. However, retroreflectors adhered to a school bus, tractor trailer, or any large commercial vehicle will also be detected and need to be addressed by an AV system accordingly. Retroreflectors associated with objects of concern, such as a worker's safety vest, bicyclist with retroreflector on person or on bike, stopped mail truck, all present obstacles with potentially non-standard maneuvers. Non-standard maneuvers may include; a stopped school bus in the right lane may not be passed whereas a common bus can, a bicyclist must be passed but some local laws require more than four feet of clearance, or a postal truck may dart out or may have an erratic and sudden acceleration or deceleration. Detecting the unique signature of the retroreflectors adhered to these vehicles or people will provide an added level of safety and alertness to the AV control system.

All retroreflectors in use today perform in both the visible and infrared, including both glass bead and plastic retroreflectors. In some embodiments, a heightened security system will detect retroreflectors that only reflect IR and not visible light, providing an increased level of unencumbered alert.

Various embodiments include a retroreflector that reflects only IR light (unlike retroreflectors in use today that reflect both visible and IR light) and a system that can detect this unique retroreflector. On any road then, in accordance with various embodiments, there may be a combination of traditional retroreflectors and IR-only retroreflectors. IR-only retroreflectors may present a new roadway safety standard to provide specific and heightened detection of objects for detection by self-driving autonomous vehicles equipped with IR scanning systems.

IR-only retroreflectors may be produced from polymers that are opaque to visible light but transparent to IR light or have a coating that acts similarly. Various plastic materials may be compounded with dyes to have this property. FIG. 5 shows the transmittance spectrum of one commercially available polycarbonate material that has this property that may be used in making retroreflector beads according to various embodiments.

In use, the scanning system will use two wavelengths of light. The first wavelength, typically 910 nm or 940 nm, may be used to scan the environment as normally. A secondary laser emitting light with a wavelength greater than 1100 nm may also be used to scan the environment. Today's retroreflectors will reflect both of these wavelengths of light. However, only the 1100 nm (or greater) laser will receive a refection from IR-only retroreflectors. In embodiments using a 1D photoelectric detector, comparison of amplitude values detected in both wavelengths at the same rotational angle and azimuth of the laser positioning module 105 will reveal retroreflectors made from IR-only material. In embodiments using s a 2D pixelated photoelectric detector, a comparison of saturated pixels detected in both wavelengths will reveal retroreflectors made from IR-only material. Operating the scanning system to detect IR-only retroreflectors may indicate objects of heightened concern for self-driving autonomous vehicles.

In various embodiments, IR-only retroreflectors may be incorporated on all future emergency vehicles, safety vest and safety equipment to enable autonomous vehicles to differentiate such objects from common roadway retroreflectors and provide a high level of detection. This may lessen the processing burden of having to eliminate unimportant retroreflectors by image analysis as described earlier.

Retroreflectors are available in an extensive array of sizes, reflectance efficiency, cost and design, and are available as a singular retroreflector or produced in an array of a multiplicity of retroreflectors. Various embodiments are applicable to all types and designs of retroreflectors.

Some embodiments use a retroreflector that is a sphere with a reflective coating. The sphere may be made from polymer or glass material and have a reflective backing that is vapor deposited, painted on, embedded into a highly reflective backing.

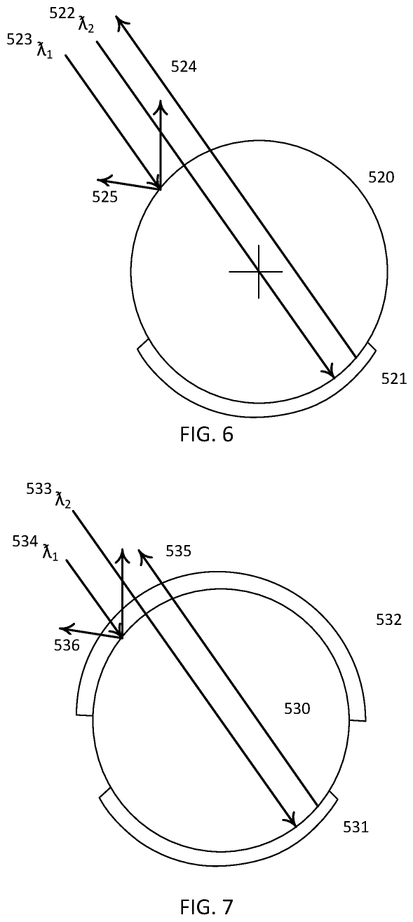

Unlike a mirror, which only reflects light directly back to a source that is precisely orthogonal to the mirror (i.e., the angle of incidence is 90 degrees), a retroreflector reflects light directly back to the source from virtually any angle of incidence. FIG. 6 depicts a beam of light 522 entering the anterior portion of a spherical retroreflector 520 and being reflected by a posterior reflecting element 521, reflecting directly back to the source 524 (lines shown separated for clarity). Spherical retroreflectors can be made as an individual reflector or made into unlimited sized arrays of retroreflectors. They are available as tapes, hard plastic, in discrete shapes, or made into flexible self-adhesive tapes for covering lengths of objects such as the side of emergency vehicles.

As illustrated in FIG. 6, the use of two different electromagnetic wavelengths (λ₁ and λ₂) in the scanning system results enables the system to differentiate IR-only retroreflectors from common retroreflectors. Retroreflector material is selected such that it may be transparent to the one wavelength λ₂ and opaque to another λ₁. A common retroreflector reflects all wavelength, whereas IR-only retroreflectors of various embodiments only reflect a certain range of IR wavelengths λ₂. Thus, photons of the incoming light 522 from the scanning system of one wavelength λ₁ will be scattered (525) while photons of the incoming light 523 from the scanning system of another wavelength λ₂ will be reflected (524).

Retroreflectors may also be of the corner cube retroreflector type, also known as a CCR or trihedral prism. Such retroreflectors are an optical structure that consists of three adjacent, mutually-orthogonal plane reflecting surfaces that form the corner of a cube. The corner cube reflects an incident ray at a specific angle, independent of the prism and beam orientations as shown in FIG. 13. The mirror coating of a corner cube can be wavelength selective—absorbing some wavelengths while reflecting others. In various embodiments employing corner cube retroreflectors, the mirror coating is configured to reflect IR photons of a particular wavelength (e.g., 1100 nm) or longer and absorb or scatter photons of shorter wavelengths.

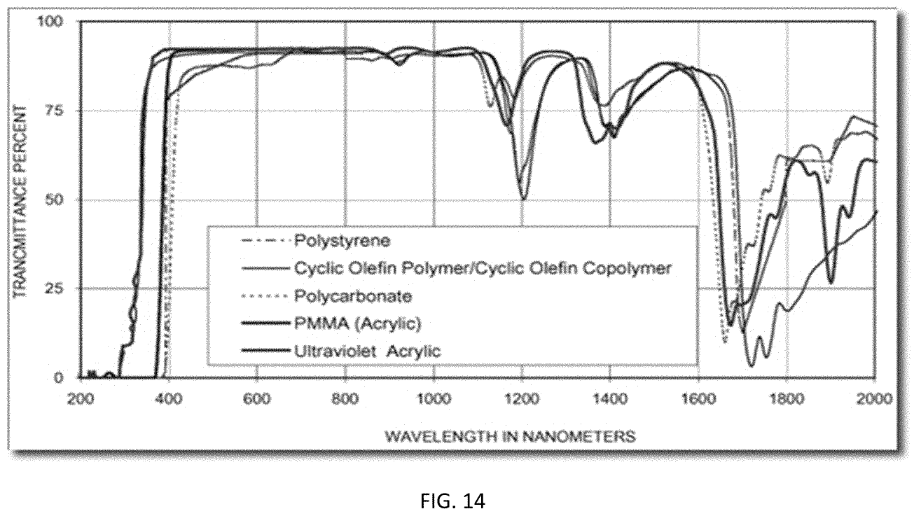

Various embodiments include an IR-only spherical retroreflector that only reflects light in a certain portion of the infrared spectrum. Such a retroreflector either scatters or absorbs most wavelengths of electromagnetic radiation, including visible and some infrared, but reflects a selected band of wavelengths of radiation, preferably infrared. Selective reflection may be accomplished in at least two ways. The first method is to use a refractive material that is opaque to all wavelengths other than a selected wavelength of interest. It is typical for a LIDAR system in an AV system to use either 950 nm or 1550 nm infrared wavelengths as an illumination source. Both are invisible to the human eye and are considered eye-safe at the intensity projected. Selecting a sphere material that is opaque to all wavelengths except 1550 nm would make the retroreflector only reflective to the 1550 nm illumination source. FIG. 6 depicts this. The first incident ray 522 may be a wavelength of 1550 nm. As shown in FIG. 14, the opacity of a polymer tends to decrease at higher wavelengths. The sphere 520 may be made of a polymer that is transmissive to 1550, such as Luminate 7276E (Epolin Company, Newark, N.J.) shown in FIG. 5. If light 523 of another incident wavelength of about 900 nm impinges on the sphere, it will be absorbed or scattered 525 by the polymer. In this manner, an IR-only retroreflector can be uniquely identified by detecting and comparing the reflected intensity of the two wavelengths.

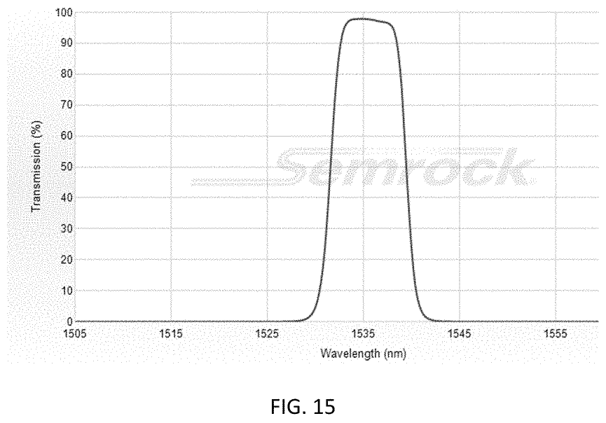

In the second method a more traditional retroreflective sphere can be partially coated with an optical filter material on its anterior to transmit only the preferred wavelength. A retroreflector with an optical filter, preferably a dichroic filter, is depicted in FIG. 7, which illustrates how a common retroreflector may be made IR selective with the use of coatings 531, 532, such as a dichroic filter coating, deposited onto the non-mirrored side of a spherical retroreflector 530 to provide optical filtering and allow one wavelength to enter and be reflected and another wavelength absorbed or diffusely reflected. The retroreflective sphere 530 has a reflective coating on its posterior 531 and a dichroic film 532 deposited on its anterior portion. A photon of suitable wavelength 533 travels through the dichroic filter 532 and is reflected 535 by the bottom mirror coating 531. Other wavelengths, shown as 534, impinge on the retroreflector but are diffusively reflected (536) or absorbed by the coating 532, thereby significantly reducing the intensity of the reflected radiation. FIG. 15 shows the bandpass profile for a dichroic filter or absorber.

Various embodiments include an IR-only corner cube retroreflector that only reflects light in a certain portion of the infrared spectrum and either scatters or absorbs other wavelengths. This may be accomplished in at least two ways. The first is to use a coating that is reflective of one wavelength and absorptive of another wavelength. For example, it is typical for LIDAR system for AV to use either 950 nm or 1550 nm wavelengths of infrared illumination. These are both eye-safe. Selecting a material that is reflective of 1550 nm but absorptive of 950 would make the retroreflector selective of the 1550 nm illumination source. Such wavelength specific reflected coatings are commercially available. For example, Alluxa® (Santa Rosa, Calif., USA) provides high-reflectivity dielectric mirrors that provide close to 100% reflection over a broad or precise range of wavelengths. A second means would be to coat the corner cube with a material that is reflective at one wavelength and transmissive of another. A dichroic filter, as detailed above, can be used to accomplish this. A corner cube retroreflector may be preferred over spherical retroreflectors for detection of singular objects at great distances.

The IR-only retroreflector will be optically unique in the environment for both its reflected intensity and for only reflecting a specific band of IR wavelength. Few natural or manufactured objects have an IR-only reflective property making the IR-only retroreflector a suitable taggant for enabling AV systems to detect objects of high import. This uniqueness is particularly detectable by machine vision sensors or LIDAR systems with addition of an additional interrogating illumination source. IR-only retroreflectors can be inexpensively incorporated into any format from a singular retroreflector to any shape or tape or painted onto a surface.

Contemporary LIDAR systems for AV navigation use only one IR wavelength of illumination. Some embodiments incorporate two different wavelengths into a scanning system. As described previously these two wavelengths are selected based on the reflectance characteristics of the IR-only retroreflectors of various embodiments.

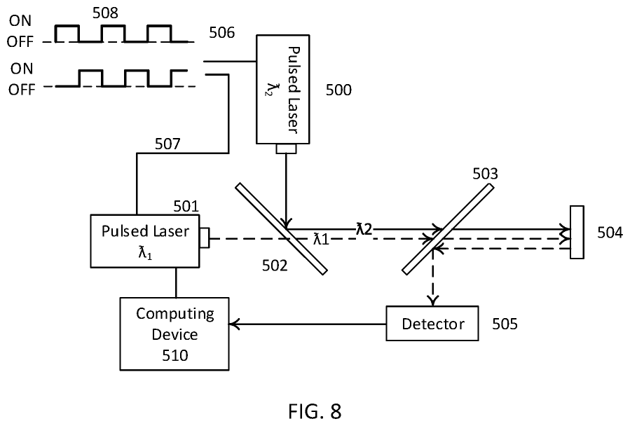

Some embodiments integrate a second pulsed laser having a wavelength that is different than that of the first laser. In FIG. 8, an embodiment of a dual laser system is shown. The first laser 500 is of a wavelength λ₁ that will not be reflected by the retroreflective target 504. A second pulsed laser 501 is of a second wavelength λ₂ that will be reflected by the retroreflective target 504. Both laser beams travel along a common path—first either through or reflected by an optical splitter 502. Each laser may be controlled (e.g., by a computing device 510) to alternately pulse as shown in 508, with an on-off control 506 driving the first laser 500 and a secondary pulse train 507 controlling the second laser 501. These pulse trains are for illustrative purposes only as there may be an off-time for both lasers during which time-of-flight data is accumulated. For most objects in the environment, both wavelengths are reflected back equally depending on their reflectivity characteristics. A detector 505 detects the reflected radiation intensity which is then converted into a digital value that may be processed and/or stored in memory by a computing device 510. The optical intensity of the two reflected beams may be compared by the computing device 510. Reflections from a traditional retroreflector typically saturate the photodetector for both wavelengths and are therefore easily differentiated from an IR-only retroreflector. If an IR-only retroreflector is detected, it is differentiated by the computer controller by having only one of the two wavelengths reflected. In other words, reflections from an IR-only retroreflector target 504 will only be received by the detector 505 during the “on” cycle of the second pulsed laser 501 when the second wavelength λ₂ of light is emitted reflected by the retroreflective, while reflections from a conventional retroreflector will be received by the detector 505 during the “on” cycle of both of the first and second pulsed lasers 500, 501.

In scanning LIDAR systems according to various embodiments, the power of the laser pulse may be modulated to minimize saturating the detector. That is, optical power may be lowered when most objects are nearby and increased when most objects are at greater distance. In this manner mostly highly reflective objects, such as retroreflectors, will saturate the photodetector 505 while reflections from other objects will not saturate the photodetector 505. With various embodiments, even if there are many highly reflective objects in the environment, only the IR-only retroreflector will appear as non-reflective with one of the two wavelengths.

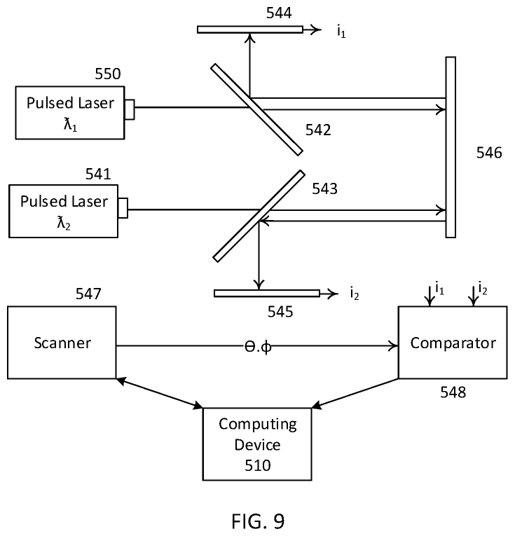

Various embodiments can be used with an existing LIDAR system. FIG. 9 illustrates this arrangement according to an embodiment. In this embodiment, a first laser 540 projects light at a wavelength λ₁ that is reflective by the IR-only retroreflector target 546, and a second laser 541 projects light at a wavelength λ₂ that is absorbed or scattered by the IR-only retroreflector 546. Laser 540 and laser 541 may be positioned on a mechanical scanner, such as a laser positioning module 105, so that both laser beams illuminate the same point in a 3-D space. Laser 540 projects a beam that passes through a first optical splitter 542 and impinges on a target 546. Any reflected light is directed back to the source and is redirected by the splitter 542 onto a first photoelectric sensor 544. The photonic intensity i₁ at the first detector 544 is preferably converted into a digital representation and sent to a comparator 548. Similarly, the second laser 541 projects a beam that passes through a second splitter 543 and impinges on the target 546. Any reflected light is directed back to the source and is redirected by the second splitter 542 onto a second photoelectric sensor 545. A photonic intensity i₂ detected by the second photoelectric sensor 545 is preferably converted into a digital representation and sent to the comparator 548. The intensity data, either in digital or analog form, from both sensors 544, 545 may be compared by the comparator 548 or by a computing device 510 coupled to the comparator. If the target 546 is an IR-only retroreflector then the detected intensity of one wavelength λ₁ will be much greater than the intensity of the other wavelength λ₂. For each point in space where this occurs, as may be determined based on rotational angle and azimuth of the laser positioning module 105 plus a time of flight measurement, a detection may be noted by the computing device 510.

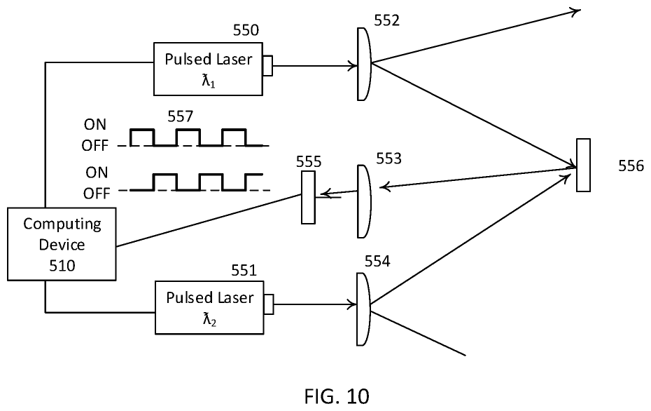

Some navigation systems do not use a scanning laser-detector arrangement but rather illuminate the entire areas of an environment, or some sub portion with a flash of wide-angle radiation. Such flash systems can be used with various embodiments. A flash system uses a broad illumination pulse and an imager. FIG. 10 illustrates such a system in which a first laser 550 is the main illumination source emitting light with a first wavelength λ₁. A lens 552 is used to diverge the beam of light emitted by the first laser 550 to cover a wide area. Objects 556 in the environment reflect back light according to their distance and reflectivity. The intensity, location, and time-of-flight of the reflected beam are determined by an imager 555, which may provide digital data to a computing device 510. An embodiment includes a second laser 551 emitting light with a wavelength λ₂ that is not reflected by the IR-only retroreflector 556. By alternately pulsing the two lasers 550, 551 as shown in the control pattern 557, such as via control signals issued by the computing device 510, the imager 555 can alternatively receive reflections from the scene in the two wavelengths λ₁, λ₁. IR-only retroreflectors can be found in the scene by the computing device 510 identifying pixels that are saturated by reflected by light emitted by the first laser 550 but detect far less or no reflection from light emitted by the second laser 551. For each pixel location where there is saturated pixel from one illumination and little or no intensity from the second illumination source a detection of an IR-only retroreflector may be noted.

LIDAR systems using scanning lasers can also be combined with flash systems as an alternative to the systems described above. A flash imager system can operate at one IR wavelength and a LIDAR system can operate at another IR wavelength in order to uniquely identify IR-only retroreflectors.

A system using two IR sensitive cameras can also be used with various embodiments. The difference between this system and the flash navigation system described above is that a dual camera system will have two imagers. In this embodiment system, two IR illumination wavelengths λ₁, λ₁ may be used to alternately illuminate the scene or illumination with both wavelengths can simultaneously illuminate the scene. Each camera contains an imager with an array of photosensitive detectors with a filter that makes each imager sensitive to one but not the other of the two wavelengths λ₁, λ₁. The cameras may be aligned, either physically or through software transform of data, such that the output of both cameras can be spatially compared. Both cameras will detect the reflectivity of objects in the environment in essentially the same way except for IR-only retroreflectors. In that case the pixels of received light reflected from the IR-only retroreflector will be saturated as described earlier and the second camera will show little or no reflection from that target. A computing device (e.g., 510) comparing all sensed pixels from own imager with the other can readily detect those pixels that have significant intensity differences. In this way an IR-only retroreflector can be uniquely identified and located in the 3-D space and a detection made. Systems that do not rely on alternating illumination but project simultaneous dual wavelength illuminations have the advantage of doubling the scan rate. A disadvantage is that more hardware is needed.

At least one AV designer is contemplating use of a radar plus a camera system for navigation. Various embodiments disclosed may be used with this type of system as well to provide enhanced and more rapid means of detecting IR-only retroreflectors. Radar cannot identify an IR-only retroreflector so an auxiliary system containing dual laser systems can be used to detect IR-only retroreflectors. Detection may be made as described in the Integrated LIDAR system.

As described above, current AV navigation systems are designed to detect objects designed for human sense and reaction. For example, the meaning of road signs is communicated by their shape, words or symbols, reflectivity and color. But current signs are not optimized for machine reading. Much like barcodes or QR codes cannot be read by a human, such codes are designed to be more reliably, more quickly, read by machine. Enhanced safety on the road suggests that signs, warning symbols on vehicles, and guides should likewise be designed for both human and machine detection.

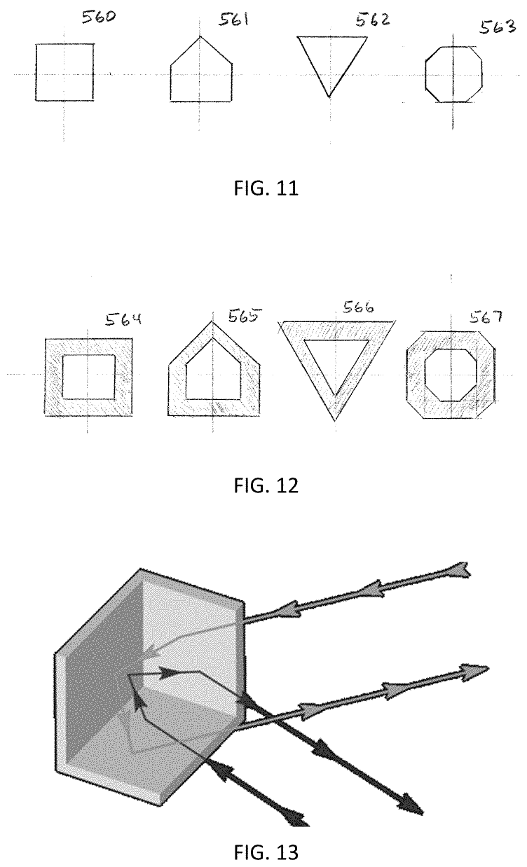

Typical shapes used on roadways and highways are shown in FIG. 11. Their geometries alone may or may not provide specific information. For example, a square shape 560 and is used to convey a large variety of information or warnings, so detecting a square or rectangular geometry does not provide much specificity. School yield signs 561, yield signs 562, and stop signs 563 are more unique. AVs are tasked with detecting and interpreting these signs on the roadway. For example, a school yield sign should alert the AV to be hypervigilant for children crossing the street, and to gradually slow in school crossing areas. The sooner a sign is detected the sooner an AV may adapt to the situation and take an action reduce its threat level. Various embodiments include modifying signs with IR-only taggants on roadways to enhance machine detection and interpretation by AV systems.

The use of IR-only retroreflectors has been shown above to provide a very unique taggant for objects of import. However, to the human eye, these materials may appear black. It may not be helpful to use an IR-only retroreflector on signs and symbols that must also be interpreted by the human eye. In some embodiments all geometries for roadways signs and symbols may be enclosed in an outline border of IR-only retroreflector material 564, 565, 566, 567 as shown in FIG. 12, which may significantly enhance vision system detection of roadway signs using IR-only retroreflector material. In some embodiments, the border will be between 3 and 12 inches to increase detectability at greater distances.

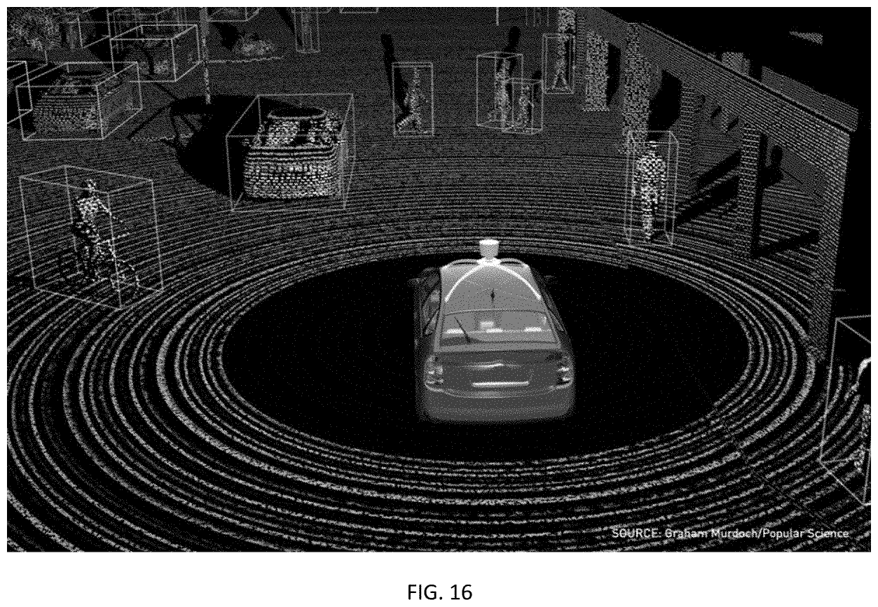

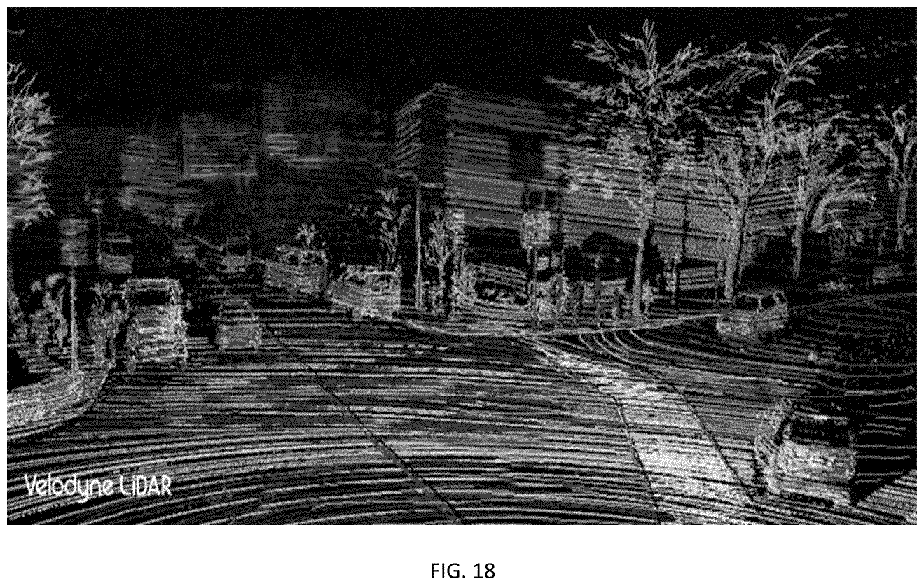

The IR-only retroreflector border provides multiple advantages. It being a border necessitates an enlargement of the sign or symbol such that it is a larger object to detect. Secondly, being a border and retaining the geometry provides a means for the machine vision system to identify the sign by its geometry. For example, detecting a pattern of IR-only retroreflectors having the octagon shape of a stop sign provides sufficient data to convey its meaning without the machine vison system having to detect color or interpret letters. Thirdly, the IR-only retroreflector boarder is to be used on only objects of import so fewer objects need to be analyzed, thus speeding detection and increasing attention of the AV navigation system to respond appropriately. Lastly, roadway signs and symbols are occasionally and partially obscured by trees, damage or vandalism, so providing an IR-only retroreflector border on signs may enable a machine vision system to interpret the unique geometry of a sign if only 50% of the geometry is visible. FIGS. 16 and 18 depict the low spatial resolution as a LIDAR system ‘sees’ its environment. Having signs and symbols with IR-only boarders will significantly enhance their detection in relatively low-resolution detection systems.

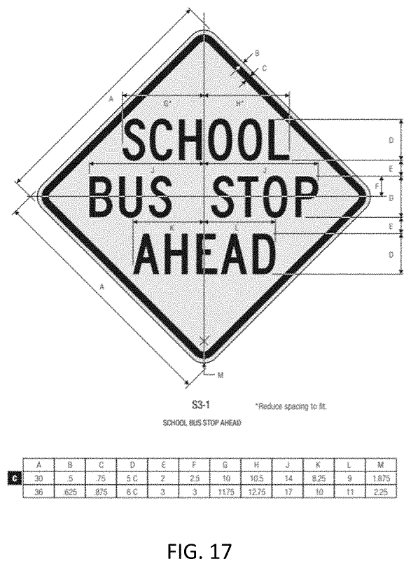

An external border of black material is typically included to help identification of a sign as shown in FIG. 17. In some embodiments, providing an external border of IR-only retroreflector material will appear to the human eye as a black border as shown in FIG. 12.

A further advantage of providing an external border of IR-only retrofit material on signs is that the retrofit materials may be disposed on the border in a manner that provides a barcode or QR code that can be read by the scanner system. For example, the retrofit or material may be disposed along the border in stripes having a barcode pattern. Providing a barcode or QR code on road signs may be used to convey information to autonomous vehicles (and similar systems) and a more efficient format than letters. For example, while a stop sign that may include the letters “STOP” to communicate with humans, an IR-only retroreflector barcode may be included in the border to communicate the same meaning to IR scanning systems of autonomous vehicles. IR-only retroreflector barcodes or QR codes may also be used to convey information to IR scanning systems of autonomous vehicles that are not intended for humans to read, as such codes would appear black to the human eye.

As with all detection or safety systems, there should be a very high level of detection accuracy or the system will generate false alarms and be rendered useless. For this reason, an algorithm for calculating a Detection Score (DS) and a Threshold Value (TV) is here provided that may be implemented on a computing system within an AV system or a LIDAR system within an AV. The DS is a determination of detection confidence by summing independent but contributory aspects of a detection. The greater the number of independent assessments made, the greater the confidence that a tagged object has been identified. The TV is used as a threshold comparator below which there is limited confidence that the object is an IR-only retroreflector. If the DS is above the TV then a detection of high confidence has been made. These factors all come from the sensing system and are related to detecting IR-only retroreflectors. If the summation of scores is equal to or greater than the TV score an alert may be sent to the navigation system. If the summation of scores is below the TV, then no alert may be sent.

The TV may also be a variable. That is, in highly congested areas where pedestrians are likely, such as inner-city streets, the TV may be lowered. In other environments where collision or pedestrians are unlikely the TV may be increased. This may be the case on open roads or highways.

DS may be a function of these variables:

DS=f(number of contiguous detections+detection of a geometric shape+repeated detections)

The following is a description of each variable and a possible scoring means. The numerical scoring provided is illustrative, with final values system dependent, but here provided to demonstrate how the DS is calculated and how it is to be compared to the TV.

Number of contiguous IR-only detections is defined as the number of detections that are contiguous in space. There may be multiple groupings of contiguous detections in a scan which would indicate multiple possible threats to the vehicle. The greater the number of contiguous detections the higher the probability of having detected an IR-only retroreflector. Detecting less than 3 contiguous detections is more indicative of noise in the system and will receive a score of 0. Detecting three to about 20 contiguous detections provides increased confidence and might receive a score of 5. A detection of greater than 20 contiguous points provides a high level of confidence and might receive a score of 10.

Geometry shape of contiguous IR-only pixels are analyzed using known machine vision algorithms to determine if they form a geometric pattern. A geometric pattern is one of a type known to be used to promote safe driving such as shown in FIGS. 11 and 12. These may include man-made signs, symbols, or reflectors on the side of emergency vehicles, tractor trailers and the like. Detecting a geometric shape indicates that the object is likely to be manmade and provides additional confidence of being an object of import. If the shape is one of those found in a database of roadway signs then a score of 10 may be given. If less than 50% of the sign is detected, a lower score of 5 may be given.

Repeat detections—navigation systems typically scan the environment ten to twenty times per second. While there are very few naturally occurring or manmade objects that will reflect in a manner as the IR-only retroreflector, it is the sustainability of the detection as the AV approaches the target that provides greater confidence of a positive detection. For each subsequent detection of an object the likelihood of a positive detection increases, for example a score of two sequential detection may be given a 1, two to five sequential detections may be given a score of five, and more than five detections may be given a score of ten.

In this manner, a maximal score of 30 may be achieved. Generally, any score over 15 may be considered to be highly confident that an IR-only object has been detected.

As disclosed above, the use of signs, symbols and reflectors that are modified specifically to be machine readable will significantly enhance confidence in detection. The above DS calculation is here modified with the anticipation that these modified tags will be used in the roadway environment.

DS=f(contiguous detections+geometric shape+repeated detections+detection of a unique symbol)

Detection of unique symbol—the objective of an IR-only retroreflector is to provide a highly unique and machine detectable taggant. In the future, it is anticipated that to significantly increase the safety of AVs, roadways will have signs modified to be more readily detectable by machine vision as described previously. An example of this is shown in FIG. 12, where the traditional human readable sign is enhanced with a border of IR-only retroreflector material. In some embodiments, the DS calculation additionally may include the detection of a unique symbol. That is for example, the detection of border geometry, or any special symbol such as the universal symbol for roadway worker, or a hospital ‘H’ symbol, etc. Detecting this unique symbol will significantly add to detection confidence and may be given a score of ten.

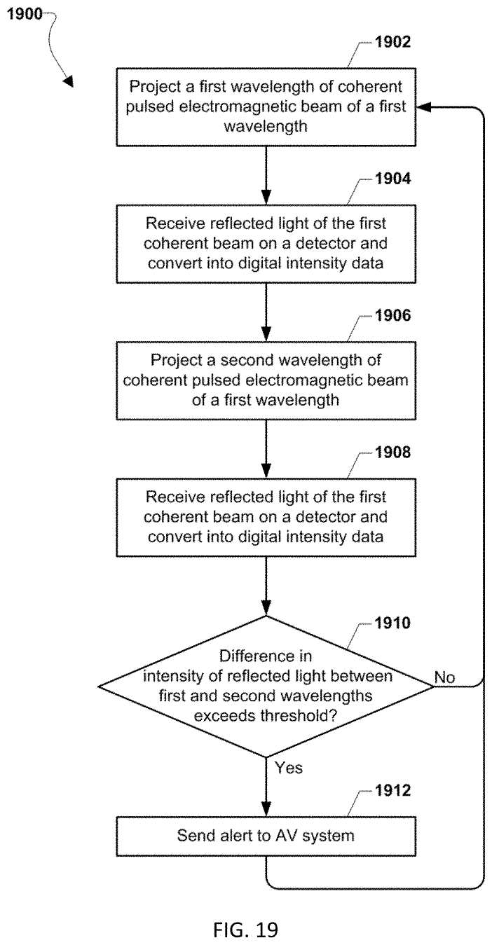

Some embodiments include methods of photonically detecting an object of high-interest having selective wavelength reflection in the scanned volume. FIG. 19 illustrates an embodiment method 1900, which may be implemented in a scanning system including a computing device (e.g., 510).

The scanning system may sequentially scan the environment by projecting a first wavelength of coherent pulsed electromagnetic beam onto a target in block 1902, and receiving reflected light of the first coherent beam on a photoelectric detector and converting the analog output of the photoelectric detector into digital intensity data in block 1904. The scanning system may sequentially scan the environment by projecting a second wavelength of coherent pulsed electromagnetic radiation onto a target in block 1906, and receiving a reflected wave of the second coherent beam onto a photoelectric detector and converting the analog output of the photoelectric detector into digital intensity data in block 1908. In determination block 1910, a computing device may compare the intensity of the reflected first wavelength light with the intensity of the reflected second wavelength light and determining whether the difference in intensity of the two reflected wavelengths exceeds a threshold. In response to determining that the intensity difference exceeds a threshold (i.e., determination block 1910=“Yes”), the computing device may send an alert to an AV system in block 1912. In response to determining that the intensity difference does not exceed the threshold (i.e., determination block 1910=“No”) or after sending an alert to the AV system in block 1912, the method 1900 may be repeated as the scanning system repeatedly scans the environment.

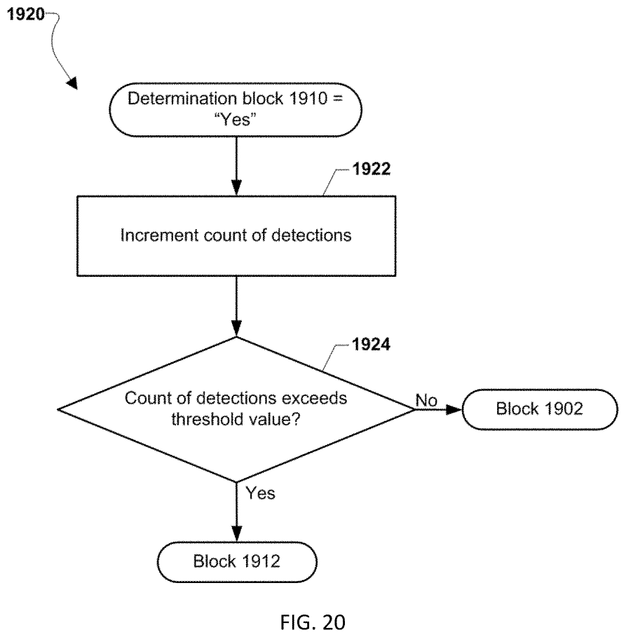

Such embodiment methods may further include determining if multiple spatially contiguous detections are made. As illustrated in FIG. 20, an embodiment method 1920 may further include summing the number of spatially contiguous alerts such as by incrementing a count of detections in each scanning sequence in block 1922 in response to determining that the intensity difference exceeds a threshold (i.e., determination block 1910=“Yes”). In determination block 1924, a computing device (e.g., 510) may determining whether the count of detections exceeds a threshold value. In response to determining that the count of detections exceeds the threshold value (i.e., determination block 1924=“Yes”), the computing device may send an alert to the AV system in block 1912. Such embodiment methods may further include summing the number of repeated temporal detections of an object in subsequent dual wavelength scans. Some embodiment methods may further include determining a geometric shape or form from detections of contiguous detections such as by comparing detected shapes with geometric shapes of road signs in a database.

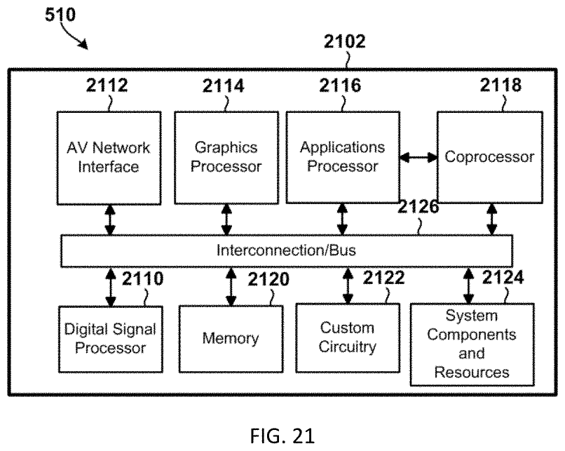

The various embodiments may include a computing device 510 that implements operations of various embodiments. Any of a variety of computing devices may be used in various embodiments, an example of which in the form of a system on chip (SOC) 2102 is illustrated in FIG. 21.

In the example computing device illustrated in FIG. 21, the computing device SOC 2102 includes a digital signal processor (DSP) 2110, an AV network interface 2112, a graphics processor 2114, an application processor 2116, one or more coprocessors 2118 (e.g., vector co-processor) connected to one or more of the processors, memory 2120, custom circuitry 2122, system components and resources 2124, all interacting via an interconnection/bus module 2126.

Each processor 2110, 2112, 2114, 2116, 2118, may include one or more cores, and each processor/core may perform operations independent of the other processors/cores. One or more of the processors may be configured with processor-executable instructions to perform operations of methods of various embodiments, including methods 1900 and 1920.

Some embodiments include a laser scanning system, which may include a laser source of a first wavelength, a laser source of a second wavelength, a photoelectric detector, an analog to digital converter, a comparator, and a processor coupled to the laser sources, photoelectric detector, an analog to digital converter, wherein the processor is configured with processor-executable instructions to perform operations including sequentially projecting a pulse of a first wavelength and receiving a reflected wave, transferring the intensity data into memory, sequentially projecting a pulse of a second wavelength and receiving a reflected wave and transferring the intensity data into memory, comparing the first intensity with the second, sending an alert if the difference is greater than a threshold value.

In such embodiments, the processor may be further configured with processor-executable instructions to perform operations including determining whether multiple contiguous saturated amplitudes have an essential geometric shape using an image processing algorithm.

Some embodiments include a laser scanning system, which may include means for sequentially scanning the environment by projecting a coherent electromagnetic radiation beam, means for receiving a reflected wave of the beam onto a photoelectric detector, means for converting the analog output of the photoelectric detector into digital data, means for recording each sequential projected beam's angle and azimuth relative to a baseline, means for storing in memory the sequential digital data with its associated angle and azimuth, means for identifying any digital data representing a saturated intensity condition, means for identifying presence of multiple contiguous digital data having a saturated condition, and means for sending an alert if one or more sets of contiguous saturated conditions exceed a predetermined number of contiguous digital data having a saturated condition. Such embodiments may further include means for determining if multiple contiguous saturated intensities have a geometric shape using an image processing algorithm. In some cases, where the average reflected intensity is low and no saturated detections made, the definition of saturated may be defined as being significantly greater than average but below totally saturated level.

Some embodiments include an IR-only retroreflector device for use in tagging objects for recognition by laser scanning systems, which may include a substrate, a reflector having essential characteristics of a retroreflector, a refractive component of the retroreflector having transmissive optical properties above 1100 nm and absorption or scattering characteristic properties below 1100 nm, and a substrate appended to, or part of, an object that may support mobile vehicle guidance. The object may be a roadway sign, a vehicle, or an object associated with a roadway. The object may be configured to assist autonomous vehicles to perform safe navigation. In some embodiments, the IR-only retroreflector material may be configured to include a barcode or QR code form from the IR-only retroreflector material. The barcode or QR code may encode information regarding the object.

Some embodiments include a method of modifying roadway signs to assist in safe navigation of autonomous vehicles, including applying a boarder of IR-only retroreflector material to a roadway sign, the IR-only retroreflector material having essential characteristics of a retroreflector, a refractive component of the retroreflector having transmissive optical properties for wavelengths equal to or larger than 1100 nm and absorption or scattering characteristic properties for wavelengths smaller than 1100 nm. In some embodiments, the IR-only retroreflector material may be configured to include a barcode or QR code form from the IR-only retroreflector material. The barcode or QR code may encode information regarding a meaning of the roadway sign.

Some embodiments include a device having unique spectral reflectance characteristics for use in roadway navigation, which may include a substrate supporting one or more reflectors, a reflector having essential characteristics of a retroreflector, an optical filtering coating on the retroreflector having transmissive optical properties for wavelengths greater than or equal to 1100 nm and absorption or scattering characteristic properties for wavelengths smaller than 1100 nm, and a substrate appended to, or part of, an object that may support mobile vehicle guidance.

Some embodiments include a device having unique spectral reflectance characteristics for use in roadway navigation, which may include a substrate supporting one or more reflectors, a reflector having essential characteristics of a retroreflector, a refractive component of the retroreflector having transmissive optical properties above a predefined wavelength and having absorption or scattering characteristic properties below said wavelength, and a substrate appended to, or part of, an object that may support mobile vehicle guidance.

Some embodiments include a device having unique spectral reflectance characteristics for use in roadway navigation, which may include a substrate supporting one or more reflectors, a reflector having essential characteristics of a retroreflector, an optical filtering coating on the retroreflector having transmissive optical properties for wavelengths greater than a predefined wavelength and having absorption or scattering characteristic properties smaller than said wavelength, and a substrate appended to, or part of, an object that may support mobile vehicle guidance.

Various embodiments provide an enhanced safety system for mobile vehicles, including a device and a unique taggant material, which can significantly improve the safety of AVs and pedestrians. Various embodiments provide redundancy for AV navigation and safety systems by using a unique optical taggant on stationary or moving objects of importance, providing higher sensitivity and recognition that results in faster response time to threats. With various embodiments, a vehicle's navigation system may be alerted sooner to take evasive actions and can be added inexpensively. Further, various embodiments include a means of minimizing false detections and enables an enhancement to roadway objects, such as signs, to be designed to optimize detection by machine vision.

The foregoing embodiments of highly-specific, long-range, low-cost means of detecting objects of high import may be extended beyond the use of laser illumination to non-coherent light emitting diode (LED) illumination. Advances in high-power LEDs, including those with infrared (IR) wavelengths (referred to herein as IR-LEDs), make possible this means of detecting IR-retroreflector (also referred to herein as IR-only retroreflector) in near to far distances. Moreover, the use of readily available IR-LEDs and CMOS array detectors may offer a more immediate path to large-scale deployment. It will still be a few years before LIDAR (laser scanning) can achieve a sufficiently low-cost profile for general use.

For highly-specific, long-range, low-cost means of detecting objects of high import using non-coherent LED illumination, the problem remains the same as for LIDAR based means. For current driver-navigated vehicles, there is no auxiliary warning system to alert drivers of objects of import in the path of travel. While driver-navigated vehicles do have back-up warning and lane change warning systems for near-field detection, there is no mechanisms or methods enabling forward looking or long-field detection of objects of import. For autonomous vehicles (AV), there is no system today or currently in development that will directly detect objects of import. Moreover, systems in development use inference systems based on radar, LIDAR, ultrasonic or camera input. These systems infer that an object may be a threat but do not directly or absolutely identifying an object as being a threat or an object of import. Objects of import may include: school buses, schoolchildren, road-workers, bicycles, pedestrians, trailer trucks, emergency vehicles, and any vehicle or object that is required by regulation to display retroreflectors.

Advantages of dual-wavelength detection of an IR-Only retroreflector using non-coherent LED illumination include day and night detection, being eye-safe within limits, not being distracting to pedestrians, and providing a highly specific spectroscopic detection that limits or eliminates false triggers. IR-only retroreflectors may appear black to a human observer while being detectable by CMOS detectors or InGaAs detectors. Illumination using high-power LEDs may be non-coherent and may maintain the specificity, detection reliability, and to a lesser degree, the range of detection similar to laser illumination. Beneficially, non-coherent LED illumination does not pose eye safety concerns that is a problem for laser illuminators. Use of IR LEDs for illumination also simplifies systems for detecting objects of high import and therefore lowers costs compared to systems that use lasers for illumination.

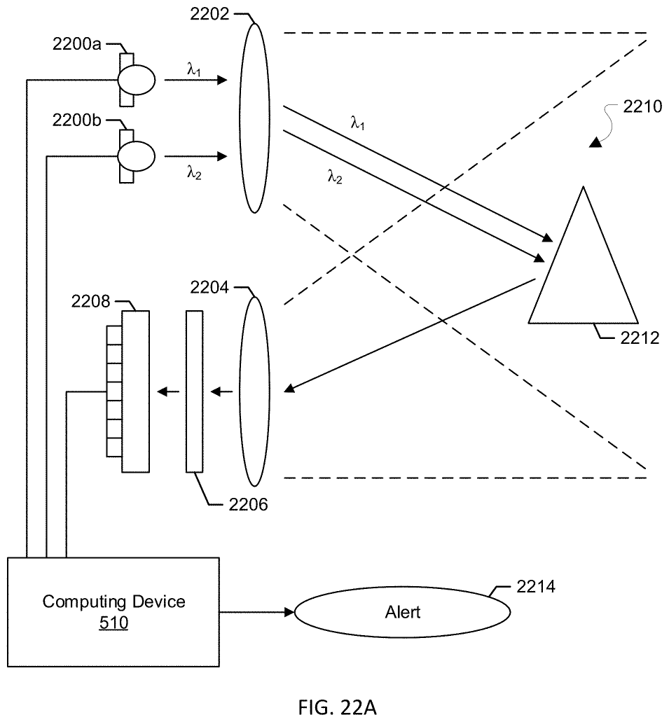

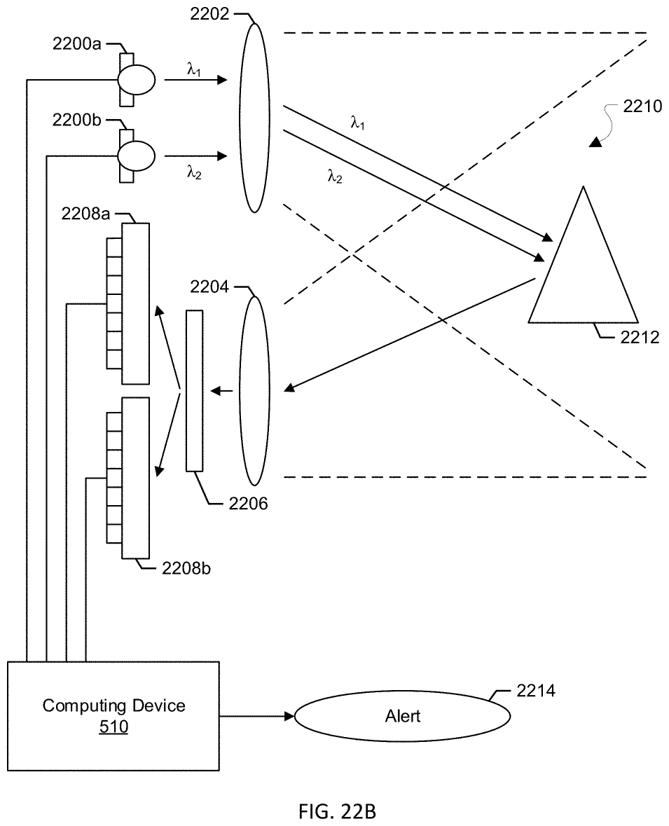

FIGS. 22A and 22B illustrate a non-coherent, dual wavelength light emitting diode (LED) IR-retroreflector (also referred to herein as IR-only retroreflector) detection systems suitable for detecting IR-retroreflectors in an environment according to various embodiments. With reference to FIGS. 1-22B, the non-coherent, dual wavelength LED IR-retroreflector detection system may include at least two IR LED illumination sources 2200a, 2200b, at least one optical projection system 2202, at least one detector optic 2204, at least one filter 2206, at least one photodetector 2208a, 2208b, and at least one computing device 510. The non-coherent, dual wavelength LED IR-retroreflector detection system may be incorporated in a human navigated vehicle, a semi-autonomous vehicle, and/or and autonomous vehicle, which may be collectively referred to herein using the term “vehicle.” Non-limiting examples include any terrestrial, aquatic, and/or aerial vehicle, such as: roadway and/or off-road vehicles, such as cars, buses, trucks, and tractor-trailers; railroad locomotives; watercraft, such as ships, personal and/or commercial vessels and autonomous aquatic vessels; aircraft, such as airborne low-flying vehicles and/or vertical takeoff and landing vehicles, robotics, and drones; and/or any device under locomotion. For example, dual wavelength LED IR-retroreflector may be deployed as navigation or identification markers that then can be detected by dual wavelength LED IR-retroreflector detection systems deployed on vehicles, watercraft, and aircraft for purposes of navigation, search and rescue, obstacle avoidance, etc.

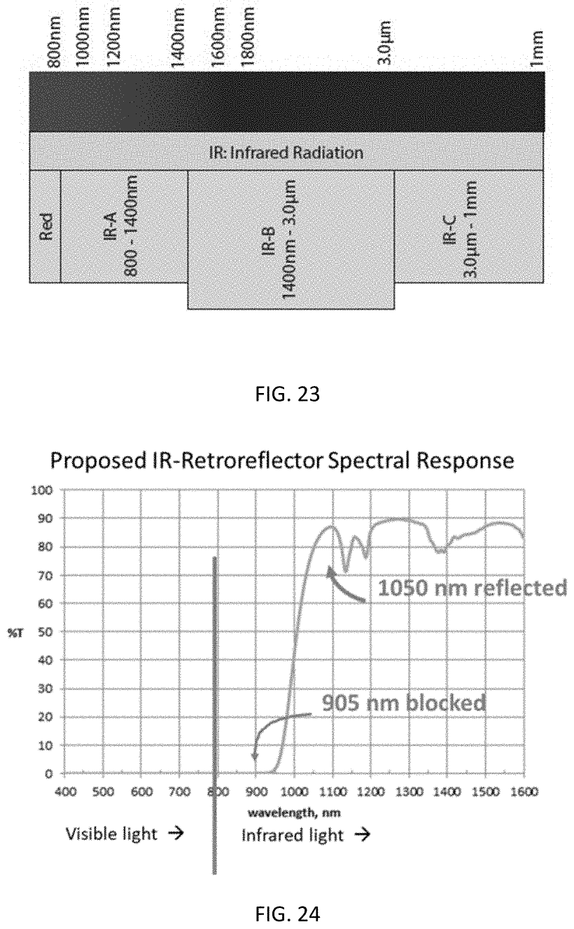

The IR LED illumination sources 2200a, 2200b may be configured to output two different wavelengths of electromagnetic radiation. For example, the IR LED illumination source 2200a may output infrared (IR) electromagnetic radiation of a first wavelength λ₁ and the IR LED illumination source 2200a may output IR electromagnetic radiation of a second wavelength λ₂ in which the two wavelengths λ₁ and λ₂ are different. As an example, the two wavelengths of IR electromagnetic radiation may be selected from the graph of example IR wavelengths for IR LED illumination sources illustrated in FIG. 23.

The configuration of the IR LED illumination sources 2200a, 2200b for specific wavelengths λ₁ and λ₂ may be based on current availability of low-cost IR LEDs and the spectral reflectivity of IR-retroreflectors (an example of which is shown in the graph illustrated in FIG. 24). In various embodiments, an IR-retroreflector may have a reflectance property configured to reflect IR electromagnetic radiation of one wavelength (e.g., λ₁) and a non-reflectance property configured to absorb, scatter, or block electromagnetic radiation of approximately the other of wavelengths (e.g., λ₂). For example, one of wavelengths λ₁ and λ₂ may be between 800 nm and 900 nm and the other of wavelengths λ₁ and λ₂ may be between 950 nm and 1050 nm. As another example, one of wavelengths λ₁ and λ₂ may be between 1500 nm BS 1600 nm, which corresponds to the spectral reflectivity of IR-retroreflectors for some LIDAR systems.

In some embodiments, the IR LED illumination sources 2200a, 2200b may each be a be single LED or an LED array. Configurations of the IR LED illumination sources 2200a, 2200b may depend on an amount of output flux, with higher numbers of LEDs of an IR LED illumination source 2200a, 2200b enabling a higher level of output flux compared to lower numbers of LEDs of the IR LED illumination source 2200a, 2200b.

The IR LED illumination sources 2200a, 2200b may be controlled, for example, by the computing device 510 to pulse outputs of IR electromagnetic radiation. In some embodiments, the IR LED illumination sources 2200a, 2200b may be pulsed in an alternating or approximately alternating manner. For example, the IR LED illumination source 2200a may output IR electromagnetic radiation of the wavelength λ₁ at times when the IR LED illumination sources 2200b is not outputting IR electromagnetic radiation of the wavelength λ₂ and vice versa. In other words, the output of IR electromagnetic radiation of the wavelength λ₁ and of IR electromagnetic radiation of the output the wavelength λ₂ may be interdigitated in time. In some embodiments, the IR LED illumination sources 2200a, 2200b may be pulsed at approximately the same time. For example, the IR LED illumination sources 2200a may output IR electromagnetic radiation of the wavelength λ₁ and the IR LED illumination sources 2200b may output IR electromagnetic radiation of the wavelength λ₂ at the same time or in overlapping pulses.

The IR electromagnetic radiation of wavelengths λ₁ and λ₂ output by the IR LED illumination sources 2200a, 2200b may be focused and/or projected by the at least one optical projection system 2202. An optical projection system 2202 may include at least one optic (not shown), such as a lens. In some embodiments, the at least one optic may be configured to focus the IR electromagnetic radiation of at least one of wavelengths λ₁ and λ₂ into a collimated beam or cone of illumination. In some embodiments, the at least one optic may be configured to focus the electromagnetic radiation of at least one of wavelengths λ₁ and λ₂ to approximately match a field-of-view of at least one photodetector 2208a, 2208b (an example of which is illustrated by the broken lines extending from the at least one detector optic 2204). In some embodiments, the optical projection system 2202 may include at least one optic for each of the IR electromagnetic radiation wavelengths λ₁ and λ₂.

Focusing the IR electromagnetic radiation of at least one of wavelengths λ₁ and λ₂ with at least one optic may include controlling a direction and/or spread of the IR electromagnetic radiation. The spread of the IR electromagnetic radiation of wavelengths λ₁ and λ₂ (an example of which is illustrated by the broken lines extending from the optical projection system 2202) may include a horizontal spread angle and a vertical spread angle, each between approximately 0 degrees and 180 degrees. For example, the horizontal spread angle may be between approximately 45 degrees and 120 degrees and the vertical spread angle may be between approximately degrees 10 and 30 degrees.

In some embodiments, the at least one optic may include a compound lens. In some embodiments, the optical projection system 2202 may include mechanisms (not shown), controlled by the computing device 510, for moving the at least one optic to adjust the direction and/or spread of the IR electromagnetic radiation of one or both of the wavelengths λ₁ and λ₂. For example, the direction of the IR electromagnetic radiation may be adjusted by the optical projection system 2202 as controlled by the computing device 510 in accordance with a direction of the vehicle in which the non-coherent, dual wavelength LED IR-retroreflector detection system is installed. For example, the optical projection system 2202 may be controlled by the computing device 510 to adjust the direction of the IR electromagnetic radiation beam or cone of illumination in accordance with a position of the vehicle steering device (e.g., a steering wheel, a yoke, etc.), a propulsion mechanism (e.g., propeller, etc.), a wheel, a skid, a track, etc. As another example, the optical projection system 2202 may be controlled by the computing device 510 to adjust the horizontal and/or vertical spread angle of the IR electromagnetic radiation in accordance with the speed of the vehicle, the location of the vehicle (e.g., urban, rural, parking lot, highway, etc.), the location of other vehicles (e.g., to reduce vertical spread when approaching another vehicle), etc. For example, the optical projection system 2202 may be controlled by the computing device 510 to adjust the direction and/or horizontal and/or vertical spread angle of the IR electromagnetic radiation beam or cone of illumination in accordance with an excepted direction of travel, speed, and/or location of the vehicle based on a current and/or future path, such as may be determined by an AI navigation unit (e.g., an autonomous driving system executing in the computing device 510). Movement of the at least one optic may be relative to the IR LED illumination sources 2200a, 2200b. In some embodiments, rather than and/or in addition to moving the at least one optic, the optical projection system 2202 mechanisms may be configured to move the IR LED illumination sources 2200a, 2200b with respect to the optics so as to adjust the direction and/or horizontal and/or vertical spread angle of the IR electromagnetic radiation beam or cone of illumination.

The IR electromagnetic radiation of wavelengths λ₁ and λ₂ may illuminate an object 2212 within the beam or cone of illumination of the IR electromagnetic radiation of wavelengths λ₁ and λ₂ and the object may reflect a portion of the IR electromagnetic radiation back to the non-coherent, dual wavelength LED IR-retroreflector detection system where reflected energy is detected by at least one photodetector 2208a, 2208b. For most objects in the environment, both of wavelengths λ₁ and λ₂ may be reflected back approximately equally depending on the reflectivity characteristics of the objects, so that the at least one photodetector 2208a, 2208b may detect both wavelengths. For IR-retroreflectors according to various embodiments, one wavelength (e.g., λ₁) of the IR electromagnetic radiation may be reflected back (referred to herein as the “reflected wavelength”) and detected by the IR-retroreflector, according to a reflectance property of the IR-retroreflector, while the other wavelength (e.g., λ₂) may not be detected by the at least one photodetector 2208a, 2208b because the energy in that wavelength was generally absorbed, scattered, or blocked by the IR-retroreflector rather than reflected back, according to a non-reflectance property of the IR-retroreflector. For an object 2212 including IR-retroreflectors, but not entirely being one or more IR-retroreflectors, various combinations of wavelengths λ₁ and λ₂ may reflect back and be detected by the at least one photodetector 2208a, 2208b depending on which parts of the object 2212 are illuminated by the IR electromagnetic radiation of wavelengths λ₁ and λ₂.

The at least one detector optic 2204 positioned before the at least one photodetector 2208a, 2208b may be configured to determine the field-of-view of the least one photodetector 2208a, 2208b. The field-of-view may be determined by an amount of reflected IR electromagnetic radiation that is able to pass through the at least one detector optic 2204. In some embodiments, the at least one detector optic 2204 may include a lens (not shown). In some embodiments, the at least one detector optic 2204 may include mechanisms (not shown), controlled by the computing device 510, for moving the at least one optic to adjust the field-of-view of the least one photodetector 2208a, 2208b. Adjusting the field of view may be implemented similarly to and/or in correspondence with adjusting the direction and/or spread angle of the IR electromagnetic radiation of wavelengths λ₁ and λ₂. For example, the detection field of view may be adjusted to approximately match the direction and/or spread angle of the IR electromagnetic radiation of wavelengths λ₁ and λ₂. In some embodiments, movement of the detector optic 2204 may be relative to the least one photodetector 2208a, 2208b. In some embodiments, the movement of the detector optic 2204 may be to control an adjustable aperture device (not shown) to narrow and/or broaden the field-of-view of the least one photodetector 2208a, 2208b. In some embodiments, the at least one detector optic 2204 may include at least one optic for each photodetectors 2208a, 2208b.

The field of view 2210 may be an area in which the spread of the transmitted electromagnetic radiation of wavelengths λ₁ and λ₂ and the field-of-view of the least one photodetector 2208a, 2208b coincide and in which the object 2212 may reside. The at least one detector optic 2204 may be configured to focus received IR electromagnetic radiation, including the reflected wavelengths λ₁ and λ₂, from the field of view 2210 onto the least one photodetector 2208a, 2208b. For example, the at least one detector optic 2204 may be configured to focus received IR electromagnetic radiation to pass through at least one filter 2206 and onto the at least one photodetector 2208a, 2208b.

The at least one filter 2206 may be configured to permit IR electromagnetic radiation, including the reflected wavelengths λ₁ and λ₂, to reach the at least one photodetector 2208a, 2208b while blocking some other electromagnetic radiation. For example, the at least one filter 2206 may prevent wavelengths of light other than IR electromagnetic radiation from reaching the at least one photodetector 2208a, 2208b. As another example, the at least one least one filter 2206 may be an optical notch filter configured to permit specific IR wavelengths, such as the reflected wavelengths λ₁ and λ₂, to pass through the filter while blocking other wavelengths of light. In some embodiments, the at least one filter 2206 may include at least one filter for each of the photodetectors 2208a, 2208b.

The at least one photodetector 2208a, 2208b may be configured to provide sufficient resolution (number of pixels) and spectral sensitivity (infrared) for the wavelengths λ₁ and λ₂ to enable detection of IR-retroreflectors in the field of view 2210. In some embodiments, the at least one photodetector 2208a, 2208b may be configured (e.g., in terms of pixel size and pixel density) to provide resolution sufficient to detect and/or resolve objects 2212 that need to be detected (e.g., traffic signs, worker safety vests, etc.) at distances sufficient to enable the vehicle control systems to take actions to avoid or respond to such objects 2212. For example, to be capable of detecting smaller objects 2212 at greater distances, the at least one photodetector 2208a, 2208b may be configured to provide higher resolution (e.g., smaller pixel sizes and greater pixel density) than if the system need only be capable of detecting objects 2212 at closer distances.

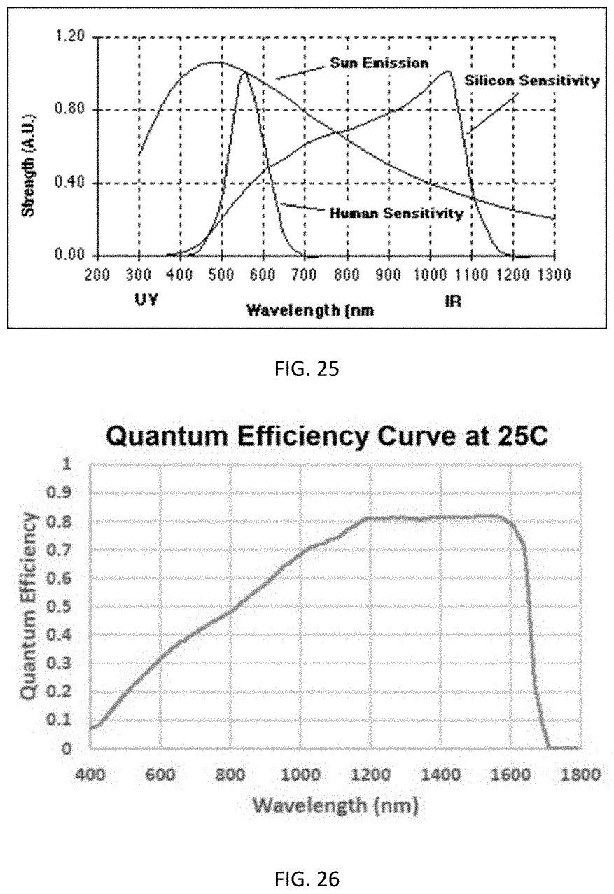

In some embodiments, the at least one photodetector 2208a, 2208b may be one or more Complementary Metal Oxide Semiconductor (CMOS detectors), which are inexpensive sensitive up to about 1100 nm. The sensitivity of CMOS detectors is shown in a graph of spectral response of a silicon photodetector in terms of strength of sensitivity vs. wavelength of reception that is illustrated in FIG. 25. In some embodiments, the at least one photodetector 2208a, 2208b may be one or more InGaAs cameras, which are more expensive than CMOS detectors have IR sensitivity between approximately 900 nm and 1600 nm. The spectral response of an InGaAs photodetector in terms of quantum efficiency vs. wavelength of reception is illustrated in FIG. 26. In some embodiments, the at least one photodetector 2208a, 2208b may be at least one photo detector array of multiple photodetectors, such as a starring array.

The at least one photodetector 2208a, 2208b may receive the IR electromagnetic radiation passed by the at least one filter 2206. In some embodiments, the at least one photodetector 2208a, 2208b may be configured to have spectral sensitivity for both of the IR electromagnetic radiation wavelengths λ₁ and λ₂, and thus be capable of detecting the reflected wavelengths λ₁ and λ₂.

As an example implementation of various embodiments, the IR electromagnetic radiation of wavelength wavelengths λ₁ and λ₂ may be emitted by the non-coherent, dual wavelength LED IR-retroreflector detection system in alternating pulses. The at least one photodetector 2208a, 2208b may receive and detect the reflected IR electromagnetic radiation of wavelength λ₁ during the emitted pulses of IR electromagnetic radiation of wavelength λ₁, and may receive and detect the reflected IR electromagnetic radiation of wavelength λ₂ during the emitted pulses of IR electromagnetic radiation of wavelength λ₂.

In some embodiments, the system may use two photodetectors with each of the detectors configured with spectral sensitivity for one of the wavelengths λ₁ or λ₂. For example, one photodetector (e.g., 2208a) may be configured with spectral sensitivity for one of the reflected wavelengths (e.g., λ₁), and the other photodetector may be configured with spectral sensitivity for one of the reflected wavelengths (e.g., λ₂). For example, IR electromagnetic radiation of wavelengths λ₁ and λ₂ may be emitted by the non-coherent, dual wavelength LED IR-retroreflector detection system in alternating pulses manner or in an approximately simultaneous manner. The photodetector 2208a may receive and detect reflected IR electromagnetic radiation of wavelength λ₁ and the photodetector 2208b may receive and detect reflected IR electromagnetic radiation of wavelength λ₂.

Reflected IR electromagnetic radiation of wavelengths λ₁ and λ₂ detected by the at least one photodetector 2208a, 2208b may be measured to identify optical intensity/photonic intensity/saturation at each pixel of the at least one photodetector 2208a, 2208b for the respective wavelengths λ₁ and λ₂. For example, the at least one photodetector 2208a, 2208b with spectral sensitivity for reflected IR electromagnetic radiation of wavelength λ₁ may measure a higher signal level for the reflected wavelength λ₁ reflected from an object 2212 that is and/or includes an IR-retroreflector configured to reflect electromagnetic radiation of wavelength λ₁ than any other objects 2212 in the field of view 2212. The at least one photodetector 2208a, 2208b with spectral sensitivity for reflected IR electromagnetic radiation of wavelength λ₂ may measure a lower signal level from the object 2212 that is and/or includes an IR-retroreflector configured to reflect electromagnetic radiation of wavelength λ₁ (or block, scatter, or absorb electromagnetic radiation of wavelength λ₂) than any other objects 2212 in the area of view 2212. Opposite detection signal levels may be recorded by the at least one photodetector 2208a, 2208b with spectral sensitivity for reflected IR electromagnetic radiation of wavelength λ₂ for an object 2212 that is and/or includes an IR-retroreflector configured to reflect IR electromagnetic radiation of wavelength λ₂. The at least one photodetector 2208a, 2208b may communicate the recorded detection signal levels to the computing device 510.

The IR electromagnetic radiation of wavelengths λ₁ and λ₂ emitted by the IR LED illumination sources 2200a, 2200b may be controlled by the computing device 510. In some embodiments, the computing device 510 may control the IR LED illumination sources 2200a, 2200b to modulate a power level for emitting the IR electromagnetic radiation of wavelengths λ₁ and λ₂. In some embodiments, the computing device 510 may control the IR LED illumination sources 2200a, 2200b to modulate a duration for emitting the IR electromagnetic radiation of wavelengths λ₁ and λ₂. In some embodiments, the computing device 510 may control the IR LED illumination sources 2200a, 2200b to modulate a delay between emitting the IR electromagnetic radiation of wavelengths λ₁ and/or λ₂. For example, the computing device 510 may modulate a delay between emitting the IR electromagnetic radiation of the same wavelength (e.g., delay between pulses of wavelength λ₁) and/or different wavelengths (e.g., delay between pulses of wavelengths λ₁ and λ₂). As another example, the computing device 510 may modulate a delay between emitting the IR electromagnetic radiation of the wavelengths output as alternating, approximately alternating, and/or approximately simultaneous pulses. Output power, duration, and/or delay for emitting the IR electromagnetic radiation may be modulated by the computing device 510 to reduce a likelihood of oversaturating the at least one photodetector 2208a, 2208b and/or to increase a likelihood of detecting an IR-retroreflector.

For example, output power, duration, and/or delay for emitting the IR electromagnetic radiation may be modulated by the computing device 510 in accordance with a speed of the vehicle, which may include a relative speed of a vehicle (e.g., closing speed with respect to an object 2212), a location of the vehicle (e.g., urban, rural, parking lot, highway, etc.), a time of day, ambient light, detection distance of an objects 2212, etc. As another example, output power, duration, and/or delay for emitting the IR electromagnetic radiation may be decreased by the computing device 510 where most objects are expected to be nearby, such as in low speed travel in urban areas or parking lots, and increased by the computing device 510 where most objects are expected to be at greater distances, such as in high speed travel on highways or in rural areas. In this manner reflections from mostly highly reflective objects, such as IR-retroreflectors, may saturate the at least one photodetector 2208a, 2208b while reflections from other objects do not saturate the at least one photodetector 2208a, 2208b. With various embodiments, even if there are many highly reflective objects in the environment, only an IR-only retroreflector may appear as approximately non-reflective of one of IR electromagnetic radiation wavelengths λ₁ and λ₂.

The time it takes for detection of reflected IR electromagnetic radiation of wavelengths λ₁ and λ₂ by the at least one photodetector 2208a, 2208b may be controlled by the computing device 510. For example, the computing device 510 may modulate the exposure time for detecting reflected IR electromagnetic radiation of wavelengths λ₁ and λ₂ by the at least one photodetector 2208a, 2208b in accordance with a speed of the vehicle, which may include a relative speed of a vehicle (e.g., closing speed with respect to an object 2212), a location of the vehicle (e.g., urban, rural, parking lot, highway, etc.), a time of day, ambient light, detection distance of an objects 2212, etc. The computing device 510 may reduce exposure time as vehicle speed increases to reduce a likelihood of motion artifacts resulting from movement of the at least one photodetector 2208a, 2208b during detection of reflected IR electromagnetic radiation of wavelengths λ₁ and λ₂. The computing device 510 may increase exposure time to enable detection of reflected IR electromagnetic radiation of wavelengths λ₁ and λ₂ from greater distances.

The computing device 510 may be any computer hardware capable of and/or capable of executing software for: controlling the illumination, capturing and storing imagery, executing an image analysis program, and/or outputting an alert 2214 (e.g., alert 108 in FIG. 1). Controlling illumination may include controlling the direction, the spread angle, and/or the power of the emitted IR electromagnetic radiation of wavelengths λ₁ and λ₂. Capturing and storing imagery may include receiving the recorded detection levels of the reflected wavelengths λ₁ and λ₂, and storing the recorded detection levels on a memory (e.g., memory 2120 in FIG. 21, cache, RAM, disk storage, etc.). For example, computing device 510 may store the recorded detection levels in association time of detection and/or the detecting photodetector 2208a, 2208b. For example, the detection levels may be stored as image files.

The computing device 510 may execute image analysis programs configured to determine whether one or more IR-retroreflectors are located in the field of view 2210 and/or whether detected IR-retroreflectors are objects of import, as described further herein. In some embodiments, the computing device 510 may execute image analysis programs configured to align multiple images, as described further herein. Outputting an alert 2214 may include generating and displaying an alert 2214 (e.g., alert 108 in FIG. 1) that an object of import is detected in the field of view 2210. For example, the alert 2214 may be output to driver and/or autonomous vehicle navigation systems of a vehicle so that an appropriate maneuver can be performed.

FIG. 23 is a graph showing example IR wavelengths suitable for emission by IR LED illumination sources 2200a, 2200b.

FIG. 24 is a graph showing an example of one IR-retroreflector's spectral response in terms of the percentage of transmittance vs. the wavelength of transmittance. With reference to FIGS. 1-24, in this example, an IR-retroreflector (e.g., retroreflector 520 in FIG. 6, retroreflector 530 in FIG. 7, object 2212 in FIGS. 22A and 22B) may have a spectral response, or a non-reflectance property, for which an electromagnetic radiation wavelength at or below approximately 940 nm may be blocked, scattered, or absorbed (or a non-reflectance property). Further, an electromagnetic radiation wavelength above approximately 940 may be reflected with little loss, according to a reflectance property, as the wavelength increases. At some wavelengths, such as at or above approximately 1025 nm, reflectance may remain high, with variance. The IR electromagnetic radiation wavelengths selected for the IR LED illumination sources 2200a, 2200b may be such that the IR electromagnetic radiation wavelength of one of the IR LED illumination sources 2200a, 2200b (e.g., approximately 1050 nm) may be reflected by the IR-retroreflector, and the IR electromagnetic radiation wavelength of one of the IR LED illumination sources 2200a, 2200b (e.g., approximately 905 nm) may be blocked, scattered, or absorbed by the IR-retroreflector.

FIG. 25 is a graph showing the spectral response of a silicon photodetector in terms of strength of sensitivity vs. wavelength of received IR electromagnetic radiation. With reference to FIGS. 1-25, a photodetector 2208a, 2208b, may be selected for a spectral response sensitive to the wavelengths of the IR LED illumination sources 2200a, 2200b. In some embodiments, the photodetector 2208a, 2208b may be a silicon photodetector, such as a CMOS detector. Such a silicon photodetector may have a sufficient spectral sensitivity to IR electromagnetic radiation up to approximately 1100 nm.

FIG. 26 is a graph showing the spectral response of an InGaAs photodetector in terms of quantum efficiency vs. wavelength of received IR electromagnetic radiation. With reference to FIGS. 1-26, an InGaAs photodetector may be selected for a spectral response sensitive to the wavelengths of the IR LED illumination sources 2200a, 2200b. Such a silicon photodetector may have a sufficient spectral sensitivity to IR electromagnetic radiation between approximately 900 nm and 1600 nm.

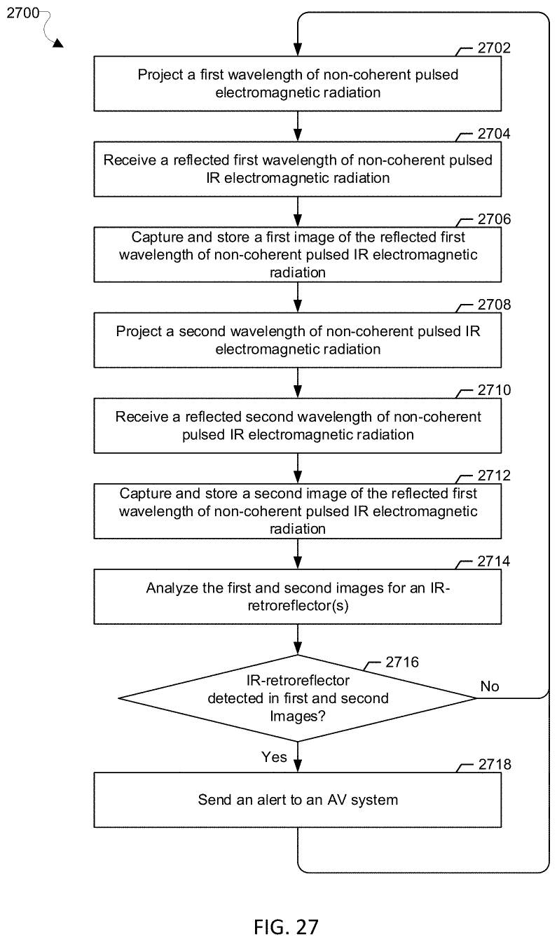

FIG. 27 is a process flow diagram illustrating a method 2700 of processing non-coherent, dual wavelength LED illumination according to various embodiments. With reference to FIGS. 1-27, the method 2700 may be implemented in a non-coherent, dual wavelength LED IR-retroreflector detection system with operations performed or controlled by the computing device 510 (including one or more components thereof), the at least two IR LED illumination sources 2200a, 2200b, and/or the at least one photodetector 2208a, 2208b. The method may also involve an optical projection system 2202, a detector optic 2204, and a filter 2206. In order to encompass the alternative configurations enabled in various embodiments, the hardware implementing the method 2700 is referred to herein as an “IR-retroreflector detection device.”

In block 2702, the IR-retroreflector detection device may project a non-coherent pulsed IR electromagnetic radiation of a first wavelength. The first wavelength may be a wavelength of IR electromagnetic radiation selected to correspond with aspects of spectral response of IR-retroreflector employed in an environment, and/or spectral sensitivity of at least one photodetector 2208a, 2208b. The IR-retroreflector detection device may control the direction, spread angle, and/or output power of the first wavelength IR electromagnetic radiation. The direction and/or spread angle may be controlled to correspond with the field-of-view of the at least one photodetector 2208a, 2208b. The output power may be controlled to reduce a likelihood of oversaturating the at least one photodetector 2208a, 2208b with reflections of IR electromagnetic radiation of the first wavelength from one or more objects 2212 in the field of view 2210 for the non-coherent, dual wavelength LED IR-retroreflector detection system. Means for performing the operations in block 2702 may include a computing device 510, a first IR LED illumination sources 2200a and an optical projection system 2202.

In block 2704, the IR-retroreflector detection device may receive reflected non-coherent pulsed IR electromagnetic radiation of the first wavelength. The reflected IR electromagnetic radiation may include reflections from one or more objects 2212 in the field of view 2210 for the non-coherent, dual wavelength LED IR-retroreflector detection system. In some embodiments, the IR-retroreflector detection device may receive IR electromagnetic radiation of multiple wavelengths (e.g., visible light, etc.), including IR electromagnetic radiation of the first wavelength. In some embodiments, at one least one filter 2206 may limit the wavelengths of electromagnetic radiation received by the IR-retroreflector detection device to wavelengths within an IR spectrum, a subset of wavelengths within the IR spectrum, and/or to approximately a single wavelength (e.g., the first wavelength) within the IR spectrum. Means for performing the operations in block 2704 may include a computing device 510, at least one photodetector 2208a, 2208b, a detector optic 2204, and optionally a filter 2206.

In block 2706, the IR-retroreflector detection device may capture and store a first image of the reflected first wavelength of non-coherent pulsed electromagnetic radiation. The first image may be captured and stored as an association of measured optical intensity/photonic intensity/saturation at each pixel of the at least one photodetector 2208a, 2208b for the first wavelength, referred to herein as detection signal levels. The first image may be captured by recoding the detection signal levels. The first image may be stored on a memory (e.g., memory 2120 in FIG. 21, cache, RAM, disk storage, etc.). In some embodiments first image may be stored in association with the recorded detection signal levels based on time of detection and/or the at least one photodetector 2208a, 2208b measuring the detection levels. For example, the detection signal levels may be stored as image files. An example image of an environment as detected by the IR-retroreflector detection device configured to have spectral sensitivity to 905 nm electromagnetic radiation is shown in an upper left portion of the image illustrated in FIG. 30. In this example image, IR-retroreflectors are configured to absorb, block, or scatter 905 nm electromagnetic radiation and appear black. Means for performing the operations in block 2706 may include a computing device 510 coupled to a memory 2120.

In block 2708, the IR-retroreflector detection device may project a second wavelength of non-coherent pulsed IR electromagnetic radiation. The second wavelength may be a wavelength of IR electromagnetic radiation selected to correspond with aspects of spectral response of IR-retroreflector employed in the environment, and/or spectral sensitivity of the at least one photodetector 2208a, 2208b, and may be different than the first wavelength. Means for performing the operations in block 2708 may include a computing device 510, a second IR LED illumination sources 2200b, at least one photodetector 2208a, 2208b, an optical projection system 2202, a detector optic 2204, and a filter 2206.

In block 2710, the IR-retroreflector detection device may receive a reflected non-coherent pulsed electromagnetic radiation of the second wavelength. Means for performing the operations in block 2710 may include a computing device 510, at least one photodetector 2208a, 2208b, a detector optic 2204, and a filter 2206.

In block 2712, the IR-retroreflector detection device may capture and store a second image of the reflected second wavelength of non-coherent pulsed electromagnetic radiation. The operations in blocks 2708, 2710, and 2712 may be implemented by the IR-retroreflector detection device in a similar manner as blocks 2702, 2704, and 2706, respectively, for the second wavelength, the second reflected wavelength, and the second image. In some embodiments, the operations blocks 2702-2712 may be performed in various orders, such as the operations in block 2702 and block 2708 may be implemented at different times and/or block 2702 and block 2708 may be implemented approximately simultaneously. An example image of an environment as detected by the IR-retroreflector detection device configured to have spectral sensitivity to 1050 nm electromagnetic radiation is shown in an upper right image illustrated in FIG. 30. In this example image, IR-retroreflectors are configured to reflect 1050 nm electromagnetic radiation and appear white. Means for performing the operations in block 2712 may include a computing device 510 coupled to a memory 2120.

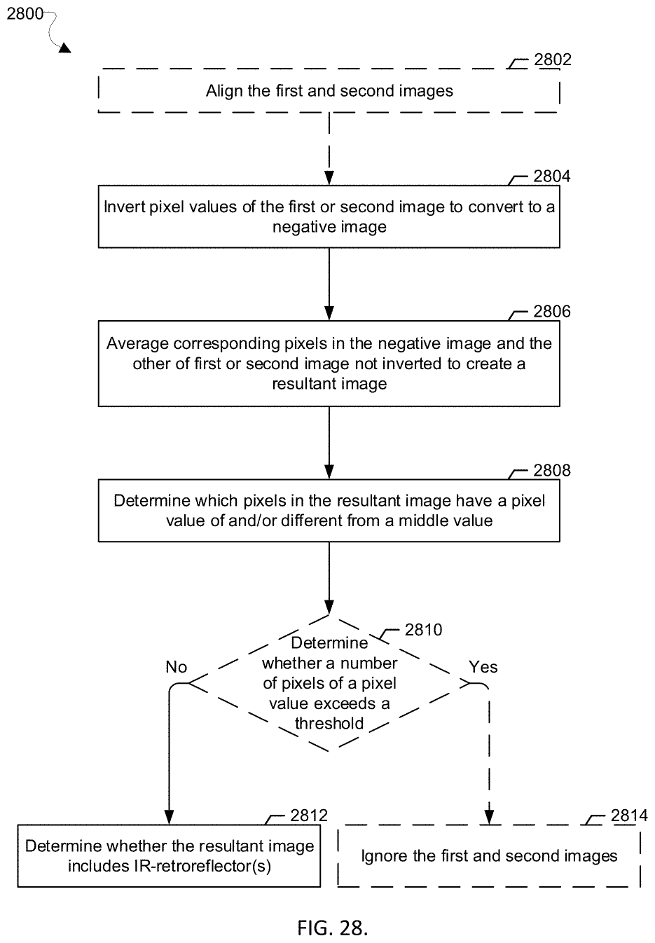

In block 2714, the IR-retroreflector detection device may analyze the first image and the second image for the presence of an IR-retroreflector(s), as described herein for the method 2800 described with reference to FIG. 28. Means for performing the operations in block 2714 may include a computing device 510 coupled to a memory 2120.

In determination block 2716, the IR-retroreflector detection device may determine whether an IR-retroreflector(s) is detected in the first image and the second image, or in a resultant image generated during analysis of the first image and the second image in block 2714. The IR-retroreflector detection device may determine whether an IR-retroreflector(s) is detected based on a result of the analysis of the first image and the second image performed in block 2716. Means for performing the operations in block 2716 may include a computing device 510 coupled to a memory 2120.

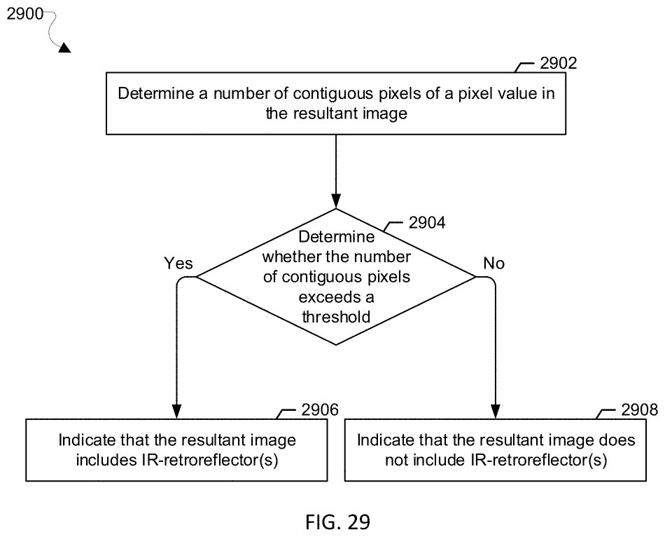

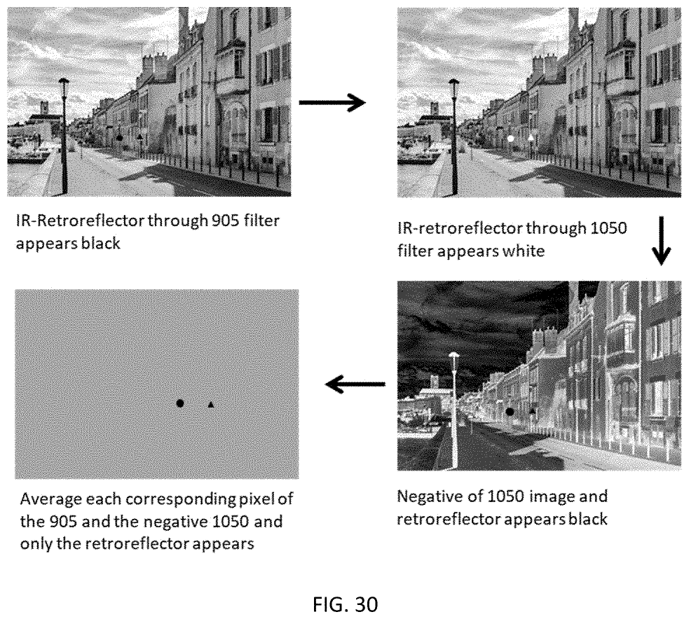

In response to determining that an IR-retroreflector(s) is detected in the first image and the second image, or in the resultant image (i.e., determination block 2716=“Yes”), the IR-retroreflector detection device may send an alert 2214 in block 2718. Sending the alert 2214 may include generating and displaying an alert 2214 that an object of import is detected in the area of view 2210. For example, the alert 2214 may be output to driver and/or autonomous vehicle navigation systems of a vehicle to notify those systems about the object of import. In some embodiments, the alert 2214 may specify a type of object of import based on an indication to the IR-retroreflector detection device of a pattern and/or a shape of the detected IR-retroreflectors, as described further in descriptions of the method 2900 with reference to FIG. 29. In some embodiment, the alert 2214 may increase in its warning effect based on a number of detected IR-retroreflectors, as described further in descriptions of the method 2900 with reference to FIG. 29. For example, the alert 2214 may have varying loudness if by audio and varying color if by display. Means for performing the operations in block 2706 may include a computing device 510.

In response to determining that an IR-retroreflector(s) is not detected in the first image and the second image, or in the resultant image (i.e., determination block 2716=“No”), or following sending the alert 2214 in block 2718, the IR-retroreflector detection device may repeat the operations of the method 2700 by projecting the first wavelength in block 2702. In some embodiments, blocks 2702-2712 may be implemented repeatedly, periodically, and/or continuously and in parallel with blocks 2714-2718.

FIG. 28 is a process flow diagram illustrating a method of processing non-coherent, dual wavelength LED illumination according to various embodiments. With reference to FIGS. 1-28, the method 2800 may be implemented by a non-coherent, dual wavelength LED IR-retroreflector detection system, including the computing device 510 (including one or more components thereof). In order to encompass the alternative configurations enabled in various embodiments, the hardware implementing the method 2800 is referred to herein as an “IR-retroreflector detection device.” The method 2800 may further describe aspects of analyzing the first image and the second image for presence of an IR-retroreflector(s) in block 2716 of the method 2700.

Each pixel of the first image and the second image may be associated with a value representing measurement of optical intensity/photonic intensity/saturation at each pixel of the at least one photodetector 2208a, 2208b by the respective reflected first wavelength and reflected second wavelength. The values may be represented as bit values “0” and “1”, and each pixel may have a value of multiple bits. For example, a pixel in an 8-bit system may have a maximum value of 11111111 and a minimum value of 00000000. For the IR-retroreflector detection device configured to have spectral sensitivity to the first wavelength of non-coherent pulsed electromagnetic radiation and the second wavelength of non-coherent pulsed electromagnetic radiation, detection of weak or no reflection of one of the first wavelength or the second wavelength, such as from an IR-retroreflector configured to block, absorb, or scatter the wavelength, may result in pixel values of approximately the minimum value for pixels detecting or failing to detect the reflected wavelength. For example, the upper left image illustrated in FIG. 30 shows the IR-retroreflectors configured to absorb, block, or scatter 905 nm electromagnetic radiation appearing black, for which the pixels have approximately the minimum value. Detection of intense reflection of the other of the first wavelength or the second wavelength, such as from the IR-retroreflector configured to reflect the wavelength, may result in pixel values of approximately the maximum value for pixels detecting the reflected wavelength. For example, the upper right image illustrated in FIG. 30 shows the IR-retroreflectors configured to reflect 1050 nm electromagnetic radiation appearing white, for which the pixels may have approximately the maximum value.

In optional block 2802, the IR-retroreflector detection device may align the first image and the second image. When the IR-retroreflector detection device or the object 2212 is moving, the first image and the second image may be aligned before performing the analysis. In some embodiments, the first image and the second image may be captured at a rate that essentially freezes motion so that there are no false detections due to motion artifacts. For example, when the first image and the second image are captured one-ten thousandth of a second apart, there may be essentially no motion artifacts. In the event of a significant movement between the two images, virtually none of the pixels of the first image and the second image may align without alignment processing. In such situations, standard image alignment processing may be used to align the first image and the second image before analysis. When the detection values of a majority of the corresponding pixels in the aligned first image and the second image do not average to within a threshold range (which may be interpreted as shades of grey in comparison to shades of white or black), this indicates motion artifacts between the aligned first image and second image, and that the first image and the second should be ignored. In some embodiments, performing operations in block 2702 and block 2708 of the method 2700 approximately simultaneously may reduce or eliminate the potential for motion artifacts. Means for performing the operations in block 2802 may include a computing device 510 coupled to a memory 2120.

In block 2804, the IR-retroreflector detection device may invert pixel values of the first image or the second image to convert to a negative image. Inverting the pixel values may include converting bit values of “0” to “1” and bit values of “1” to “0”. For example, the values of pixels having the value 11111111 may be converted to the value 00000000, the values of pixels having the value 11111110 may be converted to the value 00000001, and so on for all pixels of the first image or the second image. The result of the conversion of the values of each pixel may be the negative image having opposite pixel values of the first image or the second image. An example negative image of the image of the environment as detected by the IR-retroreflector detection device configured to have spectral sensitivity to 1050 nm electromagnetic radiation is shown in a lower right image illustrated in FIG. 30. In this example image, IR-retroreflectors appearing white in the image as captured by the IR-retroreflector detection device appear black in the negative image. Means for performing the operations in block 2804 may include a computing device 510 coupled to a memory 2120.

In block 2806, the IR-retroreflector detection device may average corresponding pixels of the negative image and the first image or the second image that was not inverted to create a resultant image. The pixels in the negative image and the first image or the second image may correspond based on position within the respective images. For example, a pixel located in a location of the negative image, such as in a corner, may correspond to a pixel located in the same location in the first image or the second image, such as in the same corner. Averaging the correspond pixels may include averaging the pixel values of each corresponding pixel from the negative image and the first image or the second image. The resulting average for a set of corresponding pixels may create a pixel value for a corresponding pixel, such as a pixel in a same location, of a resultant image. The resulting averages of each set of corresponding pixels may create pixel values for each corresponding pixel of the resultant image. All of the pixels of the negative image and the first image or the second image that have values other than approximately the maximum or minimum values may average to pixel values, referred to herein as a middle value, between approximately the maximum and minimum values. In some embodiments, the middle value may be a value and/or a range of values between approximately the maximum and minimum values. For example, the averaged pixel values, or middle value, may be approximately 11111101, which may correspond to a mid-tone (e.g., shades of grey as compared to shades of black or white). All of the pixels of the negative image and the first image or the second image that have values of approximately the maximum or minimum values may average to pixel values of approximately the maximum or minimum values. An example resultant image of averaging of a negative image, based on an image of the environment as detected by the IR-retroreflector detection device configured to have spectral sensitivity to 1050 nm electromagnetic radiation, and an image of the environment as detected by the IR-retroreflector detection device configured to have spectral sensitivity to 905 nm electromagnetic radiation is shown in a lower left image illustrated in FIG. 30. In this example image, IR-retroreflectors appearing black in the negative image and in the image as captured by the IR-retroreflector detection device appear black in the resultant image while the rest of the image appears to be an approximately uniform mid-tone. Means for performing the operations in block 2806 may include a computing device 510 coupled to a memory 2120.

In block 2808, the IR-retroreflector detection device may determine which pixels of the resultant image have a pixel value of and/or different from the middle value. The pixel value of each pixel of the resultant image may be compared to the middle value to determine which pixels of the resultant image have a pixel value of and/or different from the middle value. For example, the IR-retroreflector detection device may determine that pixels of the resultant image having pixel values that match the middle value may be pixels having pixel values of the middle value. As another example, the IR-retroreflector detection device may determine that pixels of the resultant image having pixel values that do not match the middle value, such as pixel values of approximately the maximum value and/or approximately the minimum value, may be pixels having pixel values different from the middle value. In some embodiments, the pixel locations and/or a count of pixels of the resultant image having a pixel value of and/or different from the middle value may be recorded. Means for performing the operations in block 2808 may include a computing device 510 coupled to a memory 2120.

In some embodiments, the IR-retroreflector detection device may similarly determine which pixels of the resultant image have a pixel value of and/or different from approximately the maximum value and/or approximately the minimum value. The pixel value of each pixel of the resultant image may be compared to approximately the maximum value and/or approximately the minimum value to determine which pixels of the resultant image have a pixel value of and/or different from approximately the maximum value and/or approximately the minimum value. For example, the IR-retroreflector detection device may determine that pixels of the resultant image having pixel values that match approximately the maximum value and/or approximately the minimum value are pixels having pixel values of approximately the maximum value and/or approximately the minimum value. For another example, the IR-retroreflector detection device may determine that pixels of the resultant image having pixel values that do not match the approximately the maximum value and/or approximately the minimum value, such as pixel values of the middle value, may be pixels having pixel values different from approximately the maximum value and/or approximately the minimum value. In some embodiments, the pixel locations and/or a count of pixels of the resultant image having a pixel value of and/or different from approximately the maximum value and/or approximately the minimum value may be recorded.

In optional determination block 2810, the IR-retroreflector detection device may determine whether a number of pixels of the resultant image having a specified pixel value exceeds a pixel count threshold. In some embodiments, the specified value may be a value and/or a range of values. For example, the specified value may be a value and/or a range of values of the middle value, approximately the maximum value, and/or approximately the minimum value. In some embodiments, the pixel count threshold may be a minimum and/or maximum number of pixels for identifying an object of import in the resultant image. Means for performing the operations in block 2810 may include a computing device 510 coupled to a memory 2120.

For example, the IR-retroreflector detection device may determine whether a number of pixels of the resultant image having a pixel value or a range of values different from the middle exceeds the pixel count threshold of a maximum number of pixels for identifying an object of import in the resultant image. Similarly, for example, the IR-retroreflector detection device may determine whether a number of pixels of the resultant image having a pixel value or a range of values of approximately the maximum value and/or approximately the minimum value exceeds the pixel count threshold of a maximum number of pixels for identifying an object of import in the resultant image. In other words, there may be at most a threshold number of pixels that represent an IR-retroreflector to identify an object of import in the resultant image.

In some embodiments, rather than exceeding the pixel count threshold, the IR-retroreflector detection device may determine whether a number of pixels of the resultant image having a specified pixel value falls short of a pixel count threshold in determination block 2810. For example, the IR-retroreflector detection device may determine whether a number of pixels of the resultant image having a pixel value or in a range of the middle value that falls short of the pixel count threshold of a minimum number of pixels for identifying an object of import in the resultant image. Similarly, for example, the IR-retroreflector detection device may determine whether a number of pixels of the resultant image having a pixel value or a range of values between approximately the maximum value and approximately the minimum value, falls short of the pixel count threshold of a minimum number of pixels for identifying an object of import in the resultant image. In other words, there may be at least a threshold number of pixels that do not represent an IR-retroreflector to identify an object of import in the resultant image.

For purposes of clarity and ease of explanation, the descriptions herein are made in terms of the non-limiting example of the specified value being a value and/or a range of values different from the middle value, of approximately the maximum value and/or of approximately the minimum value, and the pixel count threshold of a maximum number of pixels for identifying an object of import in the resultant image.

In response to determining that a number of pixels of the resultant image having the specified pixel value does not exceed the pixel count threshold (i.e., optional determination block 2810=“No”), or following determining which pixels of the resultant image have a pixel value of and/or different from the middle value in block 2808, the IR-retroreflector detection device may determine whether the resultant image include an IR-retroreflector(s) in block 2812. In some embodiments, whether one or more IR-retroreflectors are identified in the resultant image may be based on one or more pixels of the resultant image having a pixel value different from the middle value, of approximately the maximum value, and/or of approximately the minimum value. Means for performing the operations in block 2812 may include a computing device 510 coupled to a memory 2120.

In some embodiments, the IR-retroreflector detection device may determine whether one or more IR-retroreflectors are identified in the resultant image may be based on a number of the pixels of the resultant image having a pixel value different from the middle value, of approximately the maximum value, and/or of approximately the minimum value exceeding a minimum and/or falling short of a maximum IR-retroreflector detection threshold value of a number of pixels. For example, the number of pixels falling short of the IR-retroreflector detection threshold of a minimum number of pixels may represent too few pixels to make a determination of whether one or more IR-retroreflectors are identifiable in the resultant image. As another example, the number of pixels exceeding the IR-retroreflector detection threshold of a maximum number of pixels may represent too many pixels to make a determination of whether one or more IR-retroreflectors are identifiable in the resultant image.

In some embodiments, the IR-retroreflector detection device may determine whether one or more IR-retroreflectors are identified in the resultant image based on a number of contiguous pixels of the resultant image having a pixel value different from the middle value, of approximately the maximum value, and/or of approximately the minimum value, as described further herein for the method 2900 with reference to FIG. 29.

A determination that the resultant image includes an IR-retroreflector(s) may result in an indication to the IR-retroreflector detection device of whether there is an IR-retroreflector(s) in the first image, the second image, and/or the resultant image. In some embodiments, the IR-retroreflector detection device may generate a signal to indicate that there is an IR-retroreflector(s) in the first image, the second image, and/or the resultant image. In some embodiments, the IR-retroreflector detection device may generate a signal to indicate that there are no IR-retroreflectors in the first image, the second image, and/or the resultant image. In some embodiments, a lack of a signal may indicate that there are no IR-retroreflectors in the first image, the second image, and/or the resultant image.

In response to determining that a number of pixels of the resultant image having the specified pixel value exceeds the pixel count threshold (i.e., optional determination block 2810=“Yes”), the IR-retroreflector detection device may ignore the first image and the second image in optional block 2814. Similarly, the IR-retroreflector detection device may ignore the resultant image. In some embodiments, the IR-retroreflector detection device ignoring images may result in an indication to the IR-retroreflector detection device that there are no IR-retroreflectors in the first image, the second image, and/or the resultant image. In some embodiments, the IR-retroreflector detection device may generate a signal to indicate that there are no IR-retroreflectors in the first image, the second image, and/or the resultant image. In some embodiments, a lack of a signal may indicate that there are no IR-retroreflectors in the first image, the second image, and/or the resultant image. Means for performing the operations in block 2814 may include a computing device 510 coupled to a memory 2120.

FIG. 29 is a process flow diagram illustrating a method of processing non-coherent, dual wavelength LED illumination according to various embodiments. With reference to FIGS. 1-29, the method 2800 may be implemented by a non-coherent, dual wavelength LED IR-retroreflector detection system, including the computing device 510 (including one or more components thereof). In order to encompass the alternative configurations enabled in various embodiments, the hardware implementing the method 2800 is referred to herein as an “IR-retroreflector detection device.” The method 2900 may further describe aspects of determining whether the resultant image include an IR-retroreflector(s) in block 2812 of the method 2800, described herein with reference to FIG. 28.

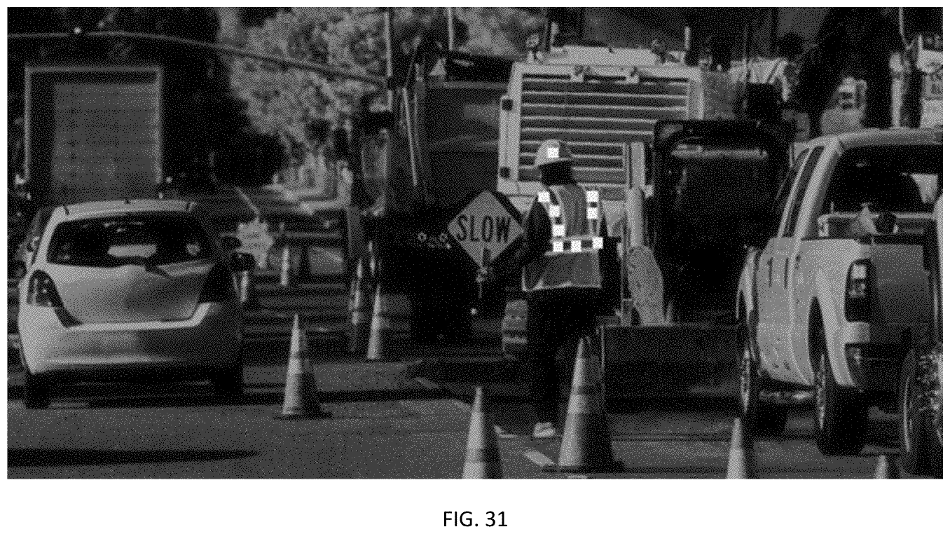

In block 2902, the IR-retroreflector detection device may determine a number of contiguous pixels of a specified pixel value in the resultant image. In some embodiments, the specified pixel value may be a value and/or a range of values. For example, the specified value may be a value and/or a range of values different from the middle value, of approximately the maximum value, and/or of approximately the minimum value. Contiguous pixels may be pixels which are no more than a designated distance from each other. For example, in a two-dimensional coordinate system in which pixel location is determined by an (x, y) coordinate pair, a contiguous pixel to a pixel located at (x, y) may be located at any coordinate combination of x, x−1, or x+1 and y, y−1, y+1, other than at (x, y). In some embodiments, the designated distance may be based on a number of contiguous pixels. For example, for a group of continuous pixels of a minimum number of pixels, the designated distance may increase based on the number of contiguous pixels in the group. In some embodiments, the contiguous pixels that may together form at least part of a pattern and/or shape (e.g., square shape 560, school yield signs 561, yield sign 562, stop signs 563 in FIG. 11, shape outlines 564, 565, 566, 567 in FIG. 12, pattern and/or shapes on construction worker attire in FIG. 31, etc.) that the IR-retroreflector detection device may determine as representing the pattern and/or shape. For example, patterns and/or shapes may have features that make them distinguishable from other patterns and/or shapes. The IR-retroreflector detection device may determine that pixels exhibiting one or more such features may be contiguous pixels representing particular patterns and/or shapes. The IR-retroreflector detection device may determine the pixels of the resultant image having the specified pixel value, which of those pixels are contiguous with other pixels having the specified value, and track the number of contiguous pixels. In some embodiments, the IR-retroreflector detection device may track a total number of contiguous pixels, regardless of whether groups of contiguous pixels are contiguous to each other, a highest number of contiguous pixels from among individual groups of contiguous pixels, individual numbers of contiguous pixels for individual groups of contiguous pixels, etc. Means for performing the operations in block 2902 may include a computing device 510 coupled to a memory 2120.

In determination block 2904, the IR-retroreflector detection device may determine whether the number of contiguous pixels exceeds a contiguous pixel threshold. The continuous pixel threshold may be a minimum number of contiguous pixels that the IR-retroreflector detection device may use to determine the presence of one or more IR-retroreflectors in the resultant image. In some embodiments, the contiguous pixel threshold may be for a total number of contiguous pixels, regardless of whether groups of contiguous pixels are contiguous to each other, a highest number of contiguous pixels from among individual groups of contiguous pixels, individual numbers of contiguous pixels for individual groups of contiguous pixels, etc. In some embodiments, the contiguous pixel threshold may be a gradient (e.g., linear and/or non-linear) of a minimum number of contiguous pixels that the IR-retroreflector detection device may use to determine the presence of one or more IR-retroreflectors in the resultant image. The IR-retroreflector detection device may compare the number of contiguous pixels tracked in block 2902 to the contiguous pixel threshold to determine whether the number of contiguous pixels exceeds a contiguous pixel threshold. In some embodiments, the IR-retroreflector detection device may compare the number of contiguous pixels tracked in block 2902 to various gradient values of the contiguous pixel threshold to determine whether the number of contiguous pixels exceeds a contiguous pixel threshold. Means for performing the operations in block 2904 may include a computing device 510 coupled to a memory 2120.

In response to determining that the number of contiguous pixels exceeds the contiguous pixel threshold (i.e., determination block 2904=“Yes”), the IR-retroreflector detection device may indicate that the resultant image includes an IR-retroreflector(s) in block 2906. Indicating that the resultant image includes an IR-retroreflector(s) may include an indication to the IR-retroreflector detection device of whether there is an IR-retroreflector(s) in the first image, the second image, and/or the resultant image. In some embodiments, indicating that the resultant image includes an IR-retroreflector(s) may include an indication to the IR-retroreflector detection device of a pattern(s) and/or a shape(s) of IR-retroreflectors in the first image, the second image, and/or the resultant image. In some embodiments, indicating that the resultant image includes an IR-retroreflector(s) may include an indication to the IR-retroreflector detection device of a number of how many IR-retroreflectors are in the first image, the second image, and/or the resultant image. In some embodiments, the IR-retroreflector detection device may generate a signal to indicate that there is an IR-retroreflector(s) in the first image, the second image, and/or the resultant image. In some embodiments, the signal may indicate the pattern(s) and/or the shape(s) of IR-retroreflectors in the first image, the second image, and/or the resultant image. In some embodiments, the signal may indicate the number of how many IR-retroreflectors are in the first image, the second image, and/or the resultant image. Means for performing the operations in block 2906 may include a computing device 510 coupled to a memory 2120.

In response to determining that the number of contiguous pixels does not exceed the contiguous pixel threshold (i.e., determination block 2904=“No”), the IR-retroreflector detection device may indicate that the resultant image does not include an IR-retroreflector(s) in block 2908. Indicating that the resultant image does not include an IR-retroreflector(s) may include an indication to the IR-retroreflector detection device of whether there is an IR-retroreflector(s) in the first image, the second image, and/or the resultant image. In some embodiments, the IR-retroreflector detection device may generate a signal to indicate that there are no IR-retroreflectors in the first image, the second image, and/or the resultant image. In some embodiments, a lack of a signal may indicate that there are no IR-retroreflectors in the first image, the second image, and/or the resultant image. Means for performing the operations in block 2908 may include a computing device 510 coupled to a memory 2120.

FIG. 31 is a graphical representation of an application of IR-retroreflectors in an environment for detection by a non-coherent, dual wavelength LED IR-retroreflector detection system. In a complex environment, in which multiple objects are in the field of view 2210, the objects may be of different sizes, in different locations, have different reflectance of various wavelengths of electromagnetic radiation, be moving at different velocities, be moving in different directions, etc. FIG. 31 illustrates and example of such a complex environment including a street with a construction site manned by construction workers. Construction workers in this complex environment are vulnerable to injury or death from vehicles traveling on the street and by the construction site. Attentive humans controlling the vehicles may be able to identify the construction workers and navigate the vehicles to avoid causing harm to the construction workers. However, inattentive humans and/or auto autonomous vehicle navigation systems of a vehicle may have difficulty identifying or fail to identify the construction workers, and, as a result, may navigate the vehicles in a manner that may cause harm to the construction workers. IR-retroreflectors may be applied to equipment of the construction workers, such as in shapes (e.g., squares) on a construction worker vest and/or helmet. The non-coherent, dual wavelength LED IR-retroreflector detection system may identify the presence of the IR-retroreflectors and generate and provide an alert to the driver and/or autonomous vehicle navigation systems of the vehicle to notify about the presence of an object having the IR-retroreflectors, in this example, the construction worker wearing the construction best having the IR-retroreflectors. The alert may prompt the driver and/or autonomous vehicle navigation system to navigate the vehicle in a manner to avoid causing harm to the construction worker.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with various embodiments may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of detecting IR-retroreflectors in an environment, comprising:
projecting a first wavelength of non-coherent pulsed electromagnetic radiation;
capturing a first image by recording detection signal levels of the first wavelength as pixel values of the first image;
projecting a second wavelength of non-coherent pulsed electromagnetic radiation;
capturing a second image by recording detection signal levels of the second wavelength as pixel values of the second image;
analyzing the first image and the second image for a presence of at least one IR-retroreflector; and
generating an alert indicating presence of at least one IR-retroreflector in the environment in response to analysis of the first image and the second image indicating the presence of the at least one IR-retroreflector.

2. The method of claim 1, wherein analyzing the first image and the second image for a presence of at least one IR-retroreflector comprises:
generating a negative image of the second image having converted pixel values of the second image;
averaging the pixel values of the first image and the converted pixel values of the negative image generating a resultant image having averaged pixel values; and
determining whether at least one pixel of the resultant image has an averaged pixel value that differs from a middle value,
wherein generating the alert indicating presence of the at least one IR-retroreflector in the environment in response to analysis of the first image and the second image indicating the presence of the at least one IR-retroreflector comprises generating the alert indicating the presence of the at least one IR-retroreflector in the environment in response to determining that at least one pixel of the resultant image has an averaged pixel value that differs from the middle value.

3. The method of claim 2, wherein analyzing the first image and the second image for a presence of at least one IR-retroreflector further comprises determining whether a number of pixels of the resultant image that have averaged pixel values that differ from the middle value falls short of a pixel count threshold,
wherein generating the alert indicating the presence of the at least one IR-retroreflector in the environment in response to determining that at least one pixel of the resultant image has an averaged pixel value that differs from the middle value comprises generating the alert indicating the presence of the at least one IR-retroreflector in the environment in response to determining that at least one pixel of the resultant image has an averaged pixel value that differs from the middle value and in response to determining that the number of pixels of the resultant image that have averaged pixel values that differ from the middle value falls short of the pixel count threshold.

4. The method of claim 2, wherein analyzing the first image and the second image for presence of at least one IR-retroreflector further comprises determining whether a number of contiguous pixels of the resultant image having averaged pixel values that differ from the middle value exceeds a contiguous pixel threshold,
wherein generating the alert indicating presence of the at least one IR-retroreflector in the environment in response to determining that at least one pixel of the resultant image has an averaged pixel value that differs from the middle value comprises generating the alert indicating presence of the at least one IR-retroreflector in the environment in response to determining that at least one pixel of the resultant image has an averaged pixel value that differs from the middle value and in response to determining that the number of contiguous pixels of the resultant image having averaged pixel values that differ from the middle value exceeds the contiguous pixel threshold.

5. The method of claim 1, wherein projecting the first wavelength and projecting the second wavelength occur at different times.

6. The method of claim 1, wherein projecting the first wavelength and projecting the second wavelength occur approximately simultaneously.

7. A system for detecting IR-retroreflectors in an environment, comprising:
means for projecting a first wavelength of non-coherent pulsed electromagnetic radiation;
means for capturing a first image by recording detection signal levels of the first wavelength as pixel values of the first image;
means for projecting a second wavelength of non-coherent pulsed electromagnetic radiation;
means for capturing a second image by recording detection signal levels of the second wavelength as pixel values of the second image;
means for analyzing the first image and the second image for a presence of at least one IR-retroreflector; and
means for generating an alert indicating presence of at least one IR-retroreflector in the environment in response to analysis of the first image and the second image indicating the presence of the at least one IR-retroreflector.

8. The system of claim 7, wherein means for analyzing the first image and the second image for a presence of at least one IR-retroreflector comprises:
means for generating a negative image of the second image having converted pixel values of the second image;
means for averaging the pixel values of the first image and the converted pixel values of the negative image generating a resultant image having averaged pixel values; and
means for determining whether at least one pixel of the resultant image has an averaged pixel value that differs from a middle value,
wherein means for generating the alert indicating presence of the at least one IR-retroreflector in the environment in response to analysis of the first image and the second image indicating the presence of the at least one IR-retroreflector comprises means for generating the alert indicating the presence of the at least one IR-retroreflector in the environment in response to determining that at least one pixel of the resultant image has an averaged pixel value that differs from the middle value.

9. The system of claim 8, wherein means for analyzing the first image and the second image for a presence of at least one IR-retroreflector further comprises means for determining whether a number of pixels of the resultant image that have averaged pixel values that differ from the middle value falls short of a pixel count threshold,
wherein means for generating the alert indicating the presence of the at least one IR-retroreflector in the environment in response to determining that at least one pixel of the resultant image has an averaged pixel value that differs from the middle value comprises means for generating the alert indicating the presence of the at least one IR-retroreflector in the environment in response to determining that at least one pixel of the resultant image has an averaged pixel value that differs from the middle value and in response to determining that the number of pixels of the resultant image that have averaged pixel values that differ from the middle value falls short of the pixel count threshold.

10. The system of claim 8, wherein means for analyzing the first image and the second image for presence of at least one IR-retroreflector further comprises means for determining whether a number of contiguous pixels of the resultant image having averaged pixel values that differ from the middle value exceeds a contiguous pixel threshold,
wherein means for generating the alert indicating presence of the at least one IR-retroreflector in the environment in response to determining that at least one pixel of the resultant image has an averaged pixel value that differs from the middle value comprises means for generating the alert indicating presence of the at least one IR-retroreflector in the environment in response to determining that at least one pixel of the resultant image has an averaged pixel value that differs from the middle value and in response to determining that the number of contiguous pixels of the resultant image having averaged pixel values that differ from the middle value exceeds the contiguous pixel threshold.

11. The system of claim 7, wherein means for projecting the first wavelength and projecting the second wavelength comprises means for projecting the first wavelength and projecting the second wavelength at different times.

12. The system of claim 7, wherein means for projecting the first wavelength and projecting the second wavelength comprises means for projecting the first wavelength and projecting the second wavelength approximately simultaneously.

13. A system for detecting IR-retroreflectors in an environment, comprising:
a first illumination source configured to output an infrared (IR) electromagnetic radiation of a first wavelength;
a second illumination source configured to output IR electromagnetic radiation of a second wavelength different from the first wavelength;
a first optic configured to focus IR electromagnetic radiation of the first wavelength and the second wavelength on a field of view;
a second optic configured with a field-of-view similar to the field of view of the first optic;
at least one photodetector configured with spectral sensitivity to IR electromagnetic radiation of the first wavelength and the second wavelength; and
a computing device coupled to the first illumination source, the second illumination source, and the at least one photodetector, and configured with computing device-executable instructions to perform operations comprising:
controlling a sequence of outputting IR electromagnetic radiation of the first wavelength by the first illumination source and IR electromagnetic radiation of the second wavelength by the second illumination source;
receiving detection signal levels of IR electromagnetic radiation of the first wavelength measured by the at least one photodetector and detection signal levels of IR electromagnetic radiation of the second wavelength measured by the at least one photodetector; and
generating an alert configured to indicate presence of at least one IR-retroreflector in the environment.

14. The system of claim 13, wherein the computing device is configured with computing device-executable instructions to perform operations further comprising controlling a duration of outputting IR electromagnetic radiation of the first wavelength by the first illumination source and IR electromagnetic radiation of the second wavelength by the second illumination source.

15. The system of claim 13, wherein the computing device is configured with computing device-executable instructions to perform operations such that controlling the sequence of outputting IR electromagnetic radiation of the first wavelength by the first illumination source and IR electromagnetic radiation of the second wavelength by the second illumination source comprises controlling outputting IR electromagnetic radiation of the first wavelength by the first illumination source and IR electromagnetic radiation of the second wavelength by the second illumination source at different times.

16. The system of claim 13, wherein the computing device is configured with computing device-executable instructions to perform operations such that controlling the sequence of outputting IR electromagnetic radiation of the first wavelength by the first illumination source and IR electromagnetic radiation of the second wavelength by the second illumination source comprises controlling outputting IR electromagnetic radiation of the first wavelength by the first illumination source and IR electromagnetic radiation of the second wavelength by the second illumination source approximately simultaneously.

17. The system of claim 13, wherein the first wavelength is less than a value selected from a range between approximately 900 nm and approximately 1,500 nm.

18. The system of claim 13, wherein the second wavelength is greater than a value selected from a range between approximately 900 nm and approximately 1,500 nm.

19. The system of claim 13, wherein the first wavelength and the second wavelength are each configured for one of reflectance property of the IR-retroreflector and a non-reflectance property of the IR-retroreflector.

20. The system of claim 13, wherein the at least one photodetector is a CMOS detector.

21. The system of claim 13, wherein the at least one photodetector is an InGaAs detector array.

22. The system of claim 13, wherein the at least one photodetector includes a first photodetector configured with spectral sensitivity to IR electromagnetic radiation of the first wavelength and a second photodetector configured with spectral sensitivity to IR electromagnetic radiation of the second wavelength.
